(19) United States
(12) Patent Application Publication
(10) Pub. No.: US 2016/0031031 A1
(43) Pub. Date: Feb. 4, 2016

(54) COATING APPARATUS AND CLEANING METHOD

(71) Applicant: FUJITSU TEN LIMITED, Kobe-shi (JP)

(72) Inventor: Tomihiro YAMAKAWA, Fukuyama-shi (JP)

(21) Appl. No.: 14/803,858

(22) Filed: Jul. 20, 2015

(30) Foreign Application Priority Data
Jul. 31, 2014 (JP) 2014-155655
Aug. 27, 2014 (JP) 2014-172111
Sep. 9, 2014 (JP) 2014-183280

(51) Int. Cl. B23K 3/08; B23K 1/20

(52) U.S. Cl. CPC B23K 3/082; B23K 1/203

(57) ABSTRACT

There is provided a coating apparatus which applies a flux liquid on a coating object. A sealed liquid container stores the flux liquid. A nozzle jets the flux liquid. A pressurizing unit supplies a gas to the inside of the liquid container, thereby pressurizing the inside of the liquid container, such that the flux liquid is supplied from the liquid container to the nozzle through a conducting pipe. A detecting unit detects the pressure of the flux liquid in the conducting pipe. A control unit performs liquid pressure control by regulating the pressure of the gas to be supplied to the inside of the liquid container, on the basis of the pressure of the flux liquid detected by the detecting unit, such that the pressure of the flux liquid to be supplied to the nozzle is maintained substantially at a constant value.

### CROSS-REFERENCE TO RELATED APPLICATIONS

This application is based on and claims priority from Japanese Patent Application No. 2014-155655 filed on Jul. 31, 2014, Japanese Patent Application No. 2014-172111 filed on Aug. 27, 2014 and Japanese Patent Application No. 2014-183280 filed on Sep. 9, 2014.

### TECHNICAL FIELD

The present invention relates to a technology for cleaning a nozzle for jetting a flux liquid. The present invention relates to a technology for applying a flux liquid on a coating object.

### BACKGROUND

In a process of manufacturing a printed circuit board, as a pre-process of soldering on the printed circuit board, a flux liquid is applied on the printed circuit board. The flux liquid is a liquid obtained by diluting a flux base material with a diluent, and is applied for purposes such as removal of an oxide film from the surface of the printed circuit board to be soldered.

As a coating apparatus for applying such a flux liquid, there has been known a coating apparatus which jets a flux liquid from a nozzle, thereby applying the flux liquid on a printed circuit board. In this coating apparatus, if the coating apparatus is stopped in a state where there is some flux liquid remaining in the nozzle, a diluent of the flux liquid vaporizes. Therefore, only a flux base material having relatively high viscosity may remain and adhere to the inner side of the nozzle.

If the flux base material adheres to the inner side of the nozzle as described above, it is feared that some problems such as a decrease in an amount of flux liquid to be jetted by the nozzle or a variation in a flux liquid jet range may occur. For this reason, it is required to regularly disassemble and clean the nozzle.

In order to avoid disassembling and cleaning as described above, there have been proposed technologies for cleaning the inside of a nozzle to remove a flux liquid. For example, there has been proposed a technology for cleaning the inside of a nozzle by supplying a cleaning liquid, instead of a flux liquid, to a supply hose for conducting the flux liquid into the nozzle by valves and the like (see Japanese Patent Application Laid-Open No. 6-106340 for instance).

However, in a case of using the technology for supplying the cleaning liquid, instead of the flux liquid, to the supply hose as described above, the flux liquid and the cleaning liquid are mixed inside the supply hose, and thus it becomes difficult to clean the inside of the nozzle with the cleaning liquid consisting of correct components. Also, it takes a long time for the flux liquid to be completely exchanged with the cleaning liquid, and it is also difficult to visually determine whether the flux liquid has been exchanged with the cleaning liquid.

Especially, in a case of using a spray nozzle having a relatively small opening size, since a flow of fluid which the nozzle can eject is small, the flux liquid and the cleaning liquid are significantly mixed, and thus problems as described above occur remarkably.

As a coating apparatus for applying a flux liquid, there has been known a coating apparatus for jetting a flux liquid from a nozzle, thereby applying the flux liquid on a printed circuit board (see Japanese Patent Application Laid-Open No. 5-111758 for instance).

FIG. 25 is a view illustrating an example of a coating apparatus 9′ according to the related art. The coating apparatus 9′ transfers a printed circuit board 8′ while holding the printed circuit board 8′ on a palette 89′, and applies a flux liquid 5′ on the printed circuit board 8′.

On the upper side of the printed circuit board 8′, electronic components 81′ are mounted. Leads 82′ of the electronic components 81′ pass through through-holes of the printed circuit board 8′ and protrude downward from the printed circuit board 8′. The leads 82′ of the electronic components 81′ are objects to be soldered, and the coating apparatus 9′ applies the flux liquid on object areas A1′ around the leads 82′ on the lower surface of the printed circuit board 8′. In the outer area from the object areas A1′ on the lower surface of the printed circuit board 8′, there is a coating prohibition component 83′ which is prohibited from being coated with the flux liquid.

A nozzle 92′ included in the coating apparatus 9′ is a spray nozzle for spraying the flux liquid 5′ from a nozzle opening 93′ formed in the upper portion of the nozzle. The nozzle 92′ sprays the flux liquid 5′ such that the flux liquid spreads as it goes upward.

In the coating apparatus 9′ according to the related art, in order to prevent the flux liquid 5′ from adhering to the coating prohibition component 83′ and the like, a cover member 88′ is interposed between the printed circuit board 8′ and the nozzle 92′. The cover member 88′ has openings only at portions corresponding to the object areas A1′ so as to cover the outer area of the printed circuit board 8′ from the object areas A1′. Therefore, the flux liquid 5′ jetted from the nozzle 92′ toward the outer area from the object areas A1′ adheres to areas A2 of the front surface of the cover member 88′. As a result, the flux liquid 5′ is applied only on the object areas A1′ of the lower surface of the printed circuit board 8′.

Meanwhile, in the coating apparatus as described above, the flux liquid for coating is stored in a sealed liquid tank, and one end of a supply hose is submerged in the flux liquid stored in the liquid tank. Thereafter, the inside of the liquid tank is pressurized by supplying a gas into the liquid tank, whereby the flux liquid is supplied from the liquid tank to the nozzle through the supply hose.

As the flux liquid is sent out, the liquid level height of the flux liquid stored in the liquid tank lowers as time goes on. For this reason, even through the inside of the liquid tank is pressurized to a constant pressure, due to the differential head of the flux liquid, the pressure of the flux liquid to be sent from the liquid tank into the supply hose decreases as time goes on.

Also, due to a pressure loss in the supply hose, the pressure of the flux liquid decreases until the flux liquid is supplied from the liquid tank to the nozzle. This pressure loss depends on the viscosity of the flux liquid. Therefore, as ambient temperature drops, the viscosity of the flux liquid increases, and thus the pressure loss increases.

As described above, the pressure of the flux liquid which is supplied to the nozzle through the supply hose varies with seasons, time, and so on. The flux liquid jet range of the nozzle depends on the pressure of the flux liquid which is supplied to the nozzle. For this reason, the flux liquid jet range of the nozzle varies with seasons, time, and so on.

In the coating apparatus according to the related art as described above, flux liquid coating ranges of the printed circuit board 8′ are defined as coating objects by the openings of the cover member 88′ (see FIG. 25). Therefore, in the coating apparatus according to the related art, even if the flux liquid jet range of the nozzle varies, any problem did not occur.

However, it is required to prepare such a cover member 88′ for each type of printed circuit board which is a coating object. Also, the flux liquid adhering to cover members 88′ becomes useless, and it is required to regularly clean cover members 88′. For these reasons, use of cover members 88′ causes the cost to rise. In this regard, a coating method which does not need interposing of a cover member 88′ has been desired. In order to realize this coating method, it is required to substantially maintain the flux liquid jet range of a nozzle, regardless of seasons, time, and so on.

In a case of replenishing the flux liquid in the coating apparatus, it is required to pull out the supply hose from the liquid tank. At this moment, air enters the hose. Therefore, after replenishment of the flux liquid is completed, if coating is performed again, bubbles are applied together with the flux liquid. In this case, unevenness of the flux liquid occurs on a printed circuit board and causes coating defects.

There have been technologies for conducting bubbles into a bubble elimination tank for eliminating bubbles from a liquid. For example, according to a technology of Japanese Patent Application Laid-Open No. 7-106294, in a case of performing plating by circulating a liquid, a branch is formed upward from a supply hose, such that bubbles rise up along the branch by buoyancy of the bubbles and reaches a bubble elimination tank, where the bubbles are removed.

However, if the liquid is circulated, whereby bubbles are conducted into the bubble elimination tank, pressure for delivering the liquid is dispersed at the branching point of the supply hose. Therefore, pressure to deliver the liquid into an application nozzle decreases, and coating defects occurs.

Also, in order to prevent the liquid from leaking from a tank, it is required to make a liquid level in the bubble elimination tank flush with a liquid level in a plating tank, and thus the flexibility of a layout of the apparatus decreases.

### SUMMARY

A first object of the present invention is to provide a technology for effectively cleaning the inside of a nozzle.

A second object of the present invention is to provide a technology for substantially maintaining the flux liquid jet range of a nozzle.

A third object of the present invention is to provide a technology for sufficiently discharging bubbles contained in a supply hose.

According to embodiments of the present embodiment, the following configurations are provided.

(1) A coating apparatus for applying a flux liquid includes: a conducting pipe that conducts a fluid to a nozzle for jetting the flux liquid; a supply unit that supplies the flux liquid into the conducting pipe; a discharging unit that supplies a gas to the conducting pipe in a state where the supply unit has stopped supply of the flux liquid to the conducting pipe, thereby discharging the flux liquid contained in the conducting pipe; and a cleaning unit that supplies a cleaning liquid to the conducting pipe after the discharging unit discharges the flux liquid from the conducting pipe, thereby cleaning the inside of the nozzle.

(2) In the coating apparatus according to (1), the discharging unit supplies the gas to the conducting pipe in a state where the cleaning unit has stopped supply of the cleaning liquid to the conducting pipe, thereby discharging the cleaning liquid contained in the conducting pipe, and the supply unit supplies the flux liquid to the conducting pipe after the discharging unit discharges the cleaning liquid from the conducting pipe.

(3) The coating apparatus according to (1) or (2), the discharging unit discharges a fluid contained in the conducting pipe, through a discharge pipe for conducting a fluid contained in the conducting pipe into an outlet, and the opening size of the discharge pipe is larger than the opening size of the nozzle.

(4) A cleaning method of cleaning a nozzle for jetting a flux liquid includes: a step (a) of supplying the flux liquid to the conducting pipe for conducting a fluid into a nozzle; a step (b) of supplying a gas to the conducting pipe in a state where supply of the flux liquid to the conducting pipe has been stopped in the step (a), thereby discharging the flux liquid contained in the conducting pipe; and a step (c) of supplying a cleaning liquid to the conducting pipe after discharging the flux liquid from the conducting pipe in the step (b), thereby cleaning the inside of the nozzle.

(5) The cleaning method according to (4) further includes a step (d) of supplying the gas to the conducting pipe in a state where supply of the cleaning liquid to the conducting pipe has been stopped in the step (c), thereby discharging the cleaning liquid contained in the conducting pipe, wherein, in step (a), the flux liquid is supplied to the conducting pipe after the cleaning liquid is discharged from the conducting pipe in the step (d).

(6) In the cleaning method according to (4) or (5), in the step (b), a fluid contained in the conducting pipe is discharged through a discharge pipe for conducting a fluid contained in the conducting pipe into an outlet, and the opening size of the discharge pipe is larger than the opening size of the nozzle.

(7) A coating apparatus for applying a flux liquid on a coating object includes: a sealed liquid container that stores the flux liquid; a nozzle that jets the flux liquid; a pressurizing unit that supplies a gas to the inside of the liquid container, thereby pressurizing the inside of the liquid container, such that the flux liquid is supplied from the liquid container to the nozzle through a conducting pipe; a detecting unit that detects the pressure of the flux liquid in the conducting pipe; and a control unit that performs liquid pressure control by regulating the pressure of the gas to be supplied to the inside of the liquid container, on the basis of the pressure of the flux liquid detected by the detecting unit, such that the pressure of the flux liquid to be supplied to the nozzle is maintained substantially at a constant value.

(8) In the coating apparatus according to (7), the detecting unit is provided in the vicinity of a connection portion of the conducting pipe with the nozzle.

(9) In the coating apparatus according to (7) or (8), the nozzle applies the flux liquid on the coating object without interposing a cover member for covering some portions of the coating object between the nozzle and the coating object.

(10) The coating apparatus according to any one of (7) to (9) further includes a valve that opens and closes a supply passage for conducting the flux liquid contained in the conducting pipe into the nozzle, wherein the valve opens the supply passage, whereby the flux liquid is jetted from the nozzle, and wherein the control unit: performs the liquid pressure control in a period when the valve closes the supply passage; and does not perform the liquid pressure control in a period when the valve opens the supply passage.

(11) A coating method of applying a flux liquid on a coating object includes: a step (a) of supplying a gas to the inside of a sealed liquid container storing the flux liquid, thereby pressurizing the inside of the liquid container, such that the flux liquid is supplied from the liquid container to a nozzle for jetting the flux liquid, through a conducting pipe; a step (b) of detecting the pressure of the flux liquid in the conducting pipe; and a step (c) of performing liquid pressure control by regulating the pressure of the gas to be supplied to the inside of the liquid container, on the basis of the pressure of the flux liquid detected in the step (b), such that the pressure of the flux liquid to be supplied to the nozzle is maintained substantially at a constant value.

(12) The coating method according to (11) further includes a step (d) of allowing a valve for opening and closing a supply passage for conducting the flux liquid contained in the conducting pipe into the nozzle, to open the supply passage, whereby the flux liquid is jetted from the nozzle, wherein, in the step (c), in a period when the valve closes the supply passage, the liquid pressure control is performed, and in a period when the valve opens the supply passage, the liquid pressure control is not performed.

(13) A coating apparatus for applying a liquid includes: an airtight tank that contains the liquid in which one end of a conducting pipe is submerged, and is pressurized such that the liquid is sent from the conducting pipe; a nozzle that receives the liquid from the tank through the conducting pipe, and applies the liquid on an object; a first valve that opens and closes a nozzle passage for conducting the liquid contained the conducting pipe into the nozzle; a discharging unit that collects bubbles contained in the conducting pipe from the conducting pipe through a branch passage formed upward from a portion of the conducting pipe, by buoyancy of the bubbles, and discharging the bubbles from an outlet; and a second valve that opens and closes the outlet, wherein in a state where the outlet is opened and the nozzle passage is closed, the discharging unit discharges the bubbles together with the liquid.

(14) In the coating apparatus according to (13), the branch passage is formed from a substantially horizontal portion of the conducting pipe.

(15) In the coating apparatus according to (13), the branch passage is formed from a portion of the conducting pipe bending from a substantial vertical direction to a substantially horizontal direction, so as to extend in the same direction as the direction of the substantially vertical portion of the conducting pipe.

(16) In the coating apparatus according to any one of (13) to (15), the discharging unit is disposed in the vicinity of the tank.

(17) A coating apparatus for applying a liquid includes: an airtight tank that contains the liquid in which one end of a conducting pipe is submerged, and is pressurized such that the liquid is sent from the conducting pipe; a nozzle that receives the liquid from the tank through the conducting pipe, and applies the liquid on an object; an accumulation tank that collects bubbles contained in the conducting pipe from the conducting pipe through a branch passage formed upward from a portion of the conducting pipe, by buoyancy of the bubbles, and accumulates the bubbles; and a discharge cock that is provided in the ceiling of the accumulation tank, and is opened such that the bubbles are discharged from the accumulation tank, wherein if the discharge cock is opened, the liquid in the accumulation tank is pushed up by the pressure of the tank, whereby the bubbles are discharged.

(18) In the coating apparatus according to (17), the branch passage is formed from a substantially horizontal portion of the conducting pipe.

(19) In the coating apparatus according to (17), the branch passage is formed from a portion of the conducting pipe bending from a substantially vertical direction to a substantially horizontal direction, so as to extend in the same direction as the direction of the substantially vertical portion of the conducting pipe.

According to the configurations of (1) to (6), the gas is supplied to the conducting pipe, whereby the flux liquid is discharged from the conducting pipe. Thereafter, the cleaning liquid is supplied to the conducting pipe. Therefore, it is possible to prevent the flux liquid and the cleaning liquid from being mixed in the conducting pipe, and it is possible to effectively clean the inside of the nozzle.

According to the configurations of (2) to (5), the air is supplied to the conducting pipe, whereby the cleaning liquid is discharged from the conducting pipe. Thereafter, the flux liquid is supplied to the conducting pipe. Therefore, it is possible to prevent the flux liquid and the cleaning liquid from being mixed in the conducting pipe, and it is possible to jet the flux liquid consisting of correct components from the nozzle.

According to the configurations of (3) to (6), a fluid in the conducting pipe is discharged through the discharge pipe having an opening size larger than that of the nozzle. Therefore, it is possible to discharge a fluid contained in the conducting pipe in a relatively short time, and it is possible to prevent a fluid from remaining in the conducting pipe.

According to the configurations of (7) to (12), the pressure of the gas in the liquid container is regulated on the basis of the pressure of the flux liquid, whereby the pressure of the flux liquid to be supplied to the nozzle is maintained substantially at a constant value. Therefore, it is possible to substantially maintain the flux liquid jet range of the nozzle.

According to the configuration of (8), the detecting unit is provided in the vicinity of a connection portion of the conducting pipe with the nozzle. Therefore, the detecting unit can correctly detect the pressure of the flux liquid to be actually supplied to the nozzle, without being affected by a pressure loss in the conducting pipe.

According to the configuration of (9), it is possible to substantially maintain the flux liquid jet range of the nozzle. Therefore, it is possible to accurately apply the flux liquid on a limited area of a coating object, without interposing a cover member between the nozzle and the coating object.

According to the configurations of (10) to (12), in a period when the valve opens the supply passage, whereby the flux liquid is jetted, the liquid pressure control is not performed. Therefore, in a period when the flux liquid is jetted, it is possible to stably jet the flux liquid.

According to the configurations of (13) to (16), in a state where the outlet is opened and the nozzle passage is closed, bubbles are discharged with the liquid. Therefore, it is possible to sufficiently discharge bubbles contained in the conducting pipe.

According to the configuration of (14), the branch passage is formed from a substantially horizontal portion of the conducting pipe, so as to extend in a direction in which bubbles rise up. Therefore, it is possible to efficiently discharge bubbles.

According to the configuration of (15), the branch passage is formed from the substantially vertical portion of the conducting pipe, so as to extend in the same direction as the direction of the substantially vertical portion. Therefore, it is possible to discharge more bubbles.

According to the configurations of (13) to (16), the discharging unit is disposed in the vicinity of the tank. Therefore, it is possible to perform exchanging of the liquid in the tank and discharging of bubbles from the conducting pipe, at close positions.

According to the configurations of (17) to (19), if the discharge cock is opened, the liquid in the accumulation tank is pushed up by the pressure of the tank, whereby bubbles are discharged. Therefore, it is possible to easily discharge accumulated bubbles.

According to the configuration of (18), as a passage for the accumulation tank, the branch passage is formed from a substantially horizontal portion of the conducting pipe, so as to extend in a direction in which bubbles rise up. Therefore, it is possible to efficiently discharge bubbles.

According to the configuration of (19), the branch passage is formed from the substantially vertical portion of the conducting pipe, so as to extend in the same direction as the direction of the substantially vertical portion. Therefore, it is possible to discharge more bubbles.

### BRIEF DESCRIPTION OF THE DRAWINGS

In the accompanying drawings:

FIG. 1 is a view illustrating an outline of a coating apparatus;

FIG. 2 is a block diagram illustrating a rough configuration of the coating apparatus;

FIG. 3 is a view illustrating a configuration of a fluid supply unit of a first embodiment;

FIG. 4 is a view illustrating a flow of operations of the coating apparatus;

FIG. 5 is a view for explaining supply of a flux liquid according to the first embodiment;

FIG. 6 is a view for explaining supply of a gas according to the first embodiment;

FIG. 7 is a view for explaining supply of a cleaning liquid according to the first embodiment;

FIG. 8 is a view illustrating a configuration of a fluid supply unit of a second embodiment;

FIG. 9 is a view for explaining supply of a flux liquid according to the second embodiment;

FIG. 10 is a view for explaining supply of a gas according to the second embodiment;

FIG. 11 is a view for explaining supply of a cleaning liquid according to the second embodiment;

FIG. 12 is a view illustrating a cleaning nozzle for ejecting a cleaning liquid to the outside of a nozzle;

FIG. 13 is a view illustrating a modification of the configuration of the fluid supply unit;

FIG. 14 is a view illustrating another modification of the configuration of the fluid supply unit;

FIG. 15 is a view illustrating an outline of another coating apparatus;

FIG. 16 is a view illustrating an example of a lower surface of a printed circuit board;

FIG. 17 is a view illustrating a rough configuration of the coating apparatus;

FIG. 18 is a view illustrating a configuration of a liquid supply unit;

FIG. 19 is a view illustrating a flow of processes of a liquid pressure control unit of a third embodiment;

FIG. 20 is a view illustrating variations of a detection value and the like of the third embodiment;

FIG. 21 is a view illustrating a flow of processes of a liquid pressure control unit of a fourth embodiment;

FIG. 22 is a view illustrating variations of a detection value and the like of the fourth embodiment;

FIG. 23 is a view illustrating variations of a detection value and the like in a case where liquid pressure control is performed in a period when a coating signal is on, as comparative examples;

FIG. 24 is a view illustrating variations of a detection value and the like in a case where liquid pressure control is not performed in a period when the coating signal is on;

FIG. 25 is a view illustrating an outline of a coating apparatus according to the related art;

FIG. 26 is a view illustrating an outline of another coating apparatus;

FIG. 27 is a view illustrating a rough configuration of the coating apparatus;

FIG. 28 is a view illustrating a configuration of a fluid supply unit of a fifth embodiment;

FIG. 29 is a view for explaining exchanging of a liquid container;

FIG. 30 is a view illustrating a flow of operations of a coating apparatus according to the fifth embodiment;

FIG. 31 is a view for explaining bubble discharge according to the fifth embodiment;

FIG. 32 is a view for explaining a modification of the fifth embodiment;

FIG. 33 is a view for explaining bubble discharge according to a sixth embodiment;

FIG. 34 is a view illustrating a flow of operations of a coating apparatus according to the sixth embodiment;

FIG. 35 is a view for explaining a modification of the sixth embodiment; and

FIG. 36 is a view illustrating a modification of a conducting pipe.

### DETAILED DESCRIPTION OF THE EMBODIMENTS

Hereinafter, a first embodiment and a second embodiment of the present invention will be described with reference to the accompanying drawings.

### 1. First Embodiment

### 1-1. Outline of Coating Apparatus

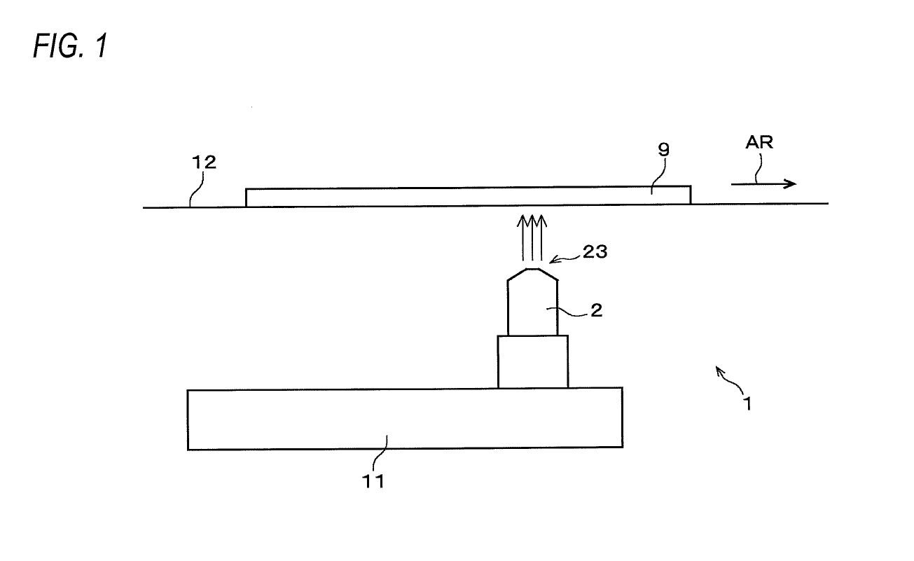

FIG. 1 is a view illustrating an outline of a coating apparatus 1 according to the present embodiment. In a process of manufacturing printed circuit boards 9, the coating apparatus 1 performs a coating process of applying a flux liquid on each printed circuit board 9, as a pre-process of soldering. The coating apparatus 1 transfers a printed circuit board 9 which is a coating object, and applies the flux liquid on the lower surface of the corresponding printed circuit board 9.

The printed circuit board 9 has various electronic components mounted thereon as soldering objects to be soldered. The coating apparatus 1 selectively applies the flux liquid on some object areas (areas where the electronic components are disposed) of the lower surface of the printed circuit board 9 as described above. The object areas become objects to be soldered.

The coating apparatus 1 includes a board transfer unit 12 for transferring printed circuit boards 9, a nozzle 2 for jetting the flux liquid, and a nozzle moving unit 11 for moving the nozzle 2.

The board transfer unit 12 includes a conveyor for moving palettes (not shown), and so on. The board transfer unit 12 moves printed circuit boards 9 mounted on the palettes, substantially in a horizontal direction as shown by an arrow AR in FIG. 1. Each printed circuit board 9 is moved to a predetermined processing position by the board transfer unit 12, and is stopped at the processing position. In this state, the corresponding printed circuit board 9 is coated. If the coating process is completed, the printed circuit board 9 is moved again by the board transfer unit 12, and is discharged to the outside of the coating apparatus 1.

The nozzle 2 is, for example, a spray nozzle for spraying the flux liquid. In a coating process, the nozzle 2 applies the flux liquid on each printed circuit board 9 disposed at the processing position. The nozzle 2 jets the flux liquid upward from a nozzle opening 23 formed in the upper portion of the nozzle, thereby applying the flux liquid on the lower surface of each printed circuit board 9.

The nozzle moving unit 11 is, for example, a Cartesian coordinate robot having the nozzle 2 fixed thereon, and moves the nozzle 2 in two axis directions along a substantially horizontal direction. In a coating process, the nozzle moving unit 11 moves the nozzle 2 along object areas of a printed circuit board 9 to be objects to be soldered. Therefore, the nozzle 2 can selectively apply the flux liquid only on the object areas of the printed circuit board 9.

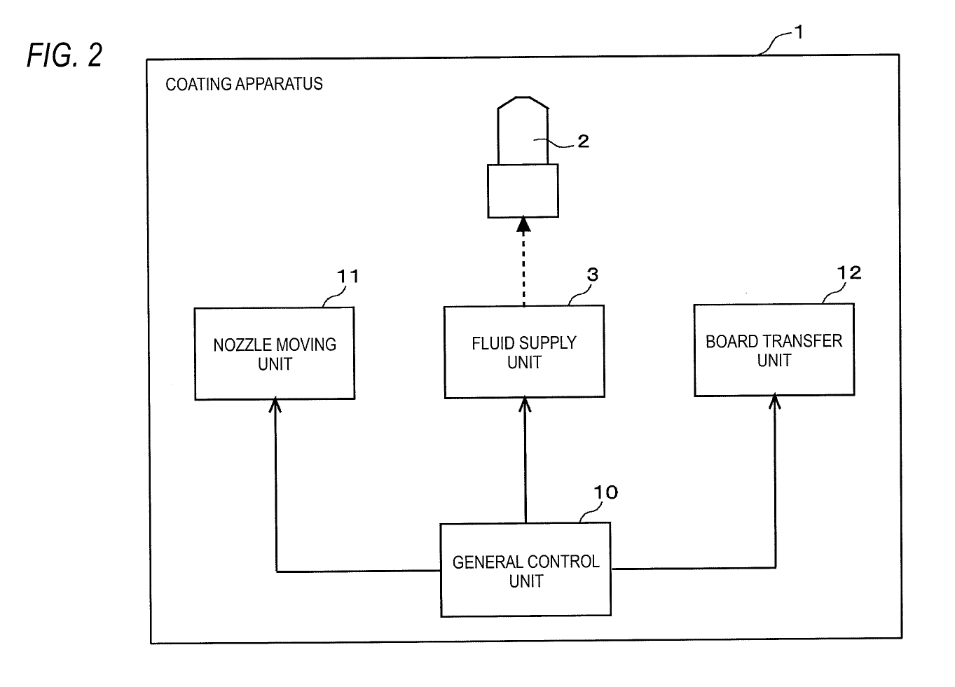

FIG. 2 is a block diagram illustrating a rough configuration of the coating apparatus 1. The coating apparatus 1 includes a general control unit 10 and a fluid supply unit 3, in addition to the board transfer unit 12, the nozzle 2, and the nozzle moving unit 11 described above.

The general control unit 10 is, for example, a programmable logic controller (PLC). The general control unit 10 performs processes according to programs, thereby generally controlling operations of the board transfer unit 12, the nozzle moving unit 11, and the fluid supply unit 3.

The fluid supply unit 3 supplies a fluid such as the flux liquid into the nozzle 2. In a coating process, the fluid supply unit 3 supplies the flux liquid into the nozzle 2 such that the flux liquid is jetted from the nozzle 2. Also, the fluid supply unit 3 can supply a cleaning liquid into the nozzle 2, thereby cleaning the inside of the nozzle 2.

### 1-2. Configuration of Fluid Supply Unit

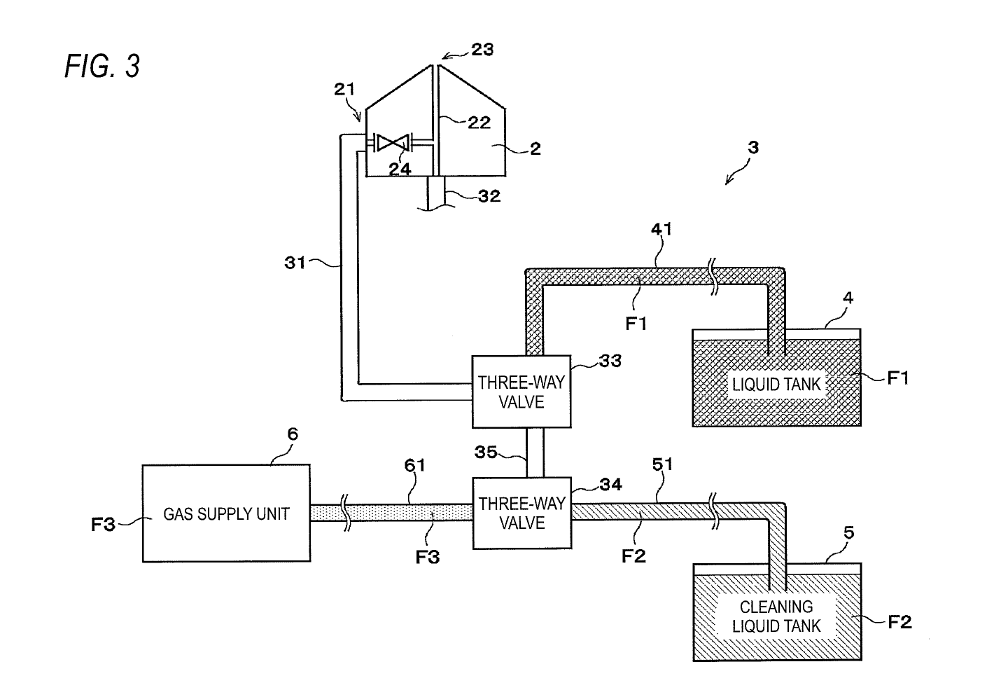

Now, a configuration of the fluid supply unit 3 will be described. FIG. 3 is a view illustrating the configuration of the fluid supply unit 3 together with the nozzle 2.

The fluid supply unit 3 includes a supply hose 31, which acts as a conducting pipe for conducting a fluid such as the flux liquid into the nozzle 2. One end of the supply hose 31 is connected to a supply port 21 of the nozzle 2. The supply hose 31 is a hollow tube formed of an elastic material such as rubber or vinyl so as to be bendable. The fluid which is supplied to the nozzle 2 through the supply hose 31 enters an internal passage 22 of the nozzle 2 from the supply port 21, and is jetted from the nozzle opening 23 of the upper portion of the nozzle to the outside of the nozzle 2.

Also, the nozzle 2 includes an internal valve 24, which is disposed on a passage connecting the supply port 21 and the internal passage 22 and is a two-way valve. The internal valve 24 opens and closes the passage connecting the supply port 21 and the internal passage 22, according to control of the general control unit 10. In a case where the internal valve 24 closes that passage, supply of the fluid from the supply hose 31 into the internal passage 22 of the nozzle 2 is stopped.

In a case of supplying the flux liquid from the supply hose 31 into the nozzle 2, if the flux liquid enters the internal passage 22 of the nozzle 2, the flux liquid is pressurized by a gas which is supplied from a gas hose 32 connected to a lower portion of the nozzle 2, thereby atomizing. As a result, the nozzle 2 sprays the flux liquid from the nozzle opening 23.

Also, the fluid supply unit 3 includes a liquid tank 4, a cleaning liquid tank 5, a gas supply unit 6, a first three-way valve 33, and a second three-way valve 34.

Each of the first three-way valve 33 and the second three-way valve 34 has two inlets and one outlet, and opens a passage connecting one of the two inlets and the outlet while closing a passage connecting the other one of the two inlets and the outlet. Operations of these three-way valves 33 and 34 are controlled by the general control unit 10.

One end of the supply hose 31 is connected to the nozzle 2, and the other end is connected to the outlet of the first three-way valve 33. Therefore, a fluid which is supplied from the outlet of the first three-way valve 33 into the supply hose 31 is supplied to the nozzle 2 through the supply hose 31. Also, one of the inlets of the first three-way valve 33 and the outlet of the second three-way valve 34 are connected by a coupling hose 35 formed of an elastic material so as to be bendable.

The liquid tank 4 is a supply source for supplying a flux liquid F1, and stores the flux liquid F1. The flux liquid F1 is, for example, a liquid obtained by diluting a flux base material such as rosin with a diluent such as isopropyl alcohol (IPA).

To the liquid tank 4, a liquid hose 41 formed of an elastic material so as to be bendable is connected. One end of the liquid hose 41 is disposed inside the liquid tank 4, and the other end is connected to one inlet of the first three-way valve 33. Since the inside of the liquid tank 4 is pressurized by a compressed gas, the liquid tank 4 supplies the pressurized flux liquid F1 toward the first three-way valve 33 through the liquid hose 41.

The cleaning liquid tank 5 is a supply source for supplying a cleaning liquid F2, and stores the cleaning liquid F2. The cleaning liquid F2 is, for example, a liquid identical to the diluent of the flux liquid F1, such as isopropyl alcohol (IPA). Therefore, if the flux liquid F1 and the cleaning liquid F2 come into contact with each other, these liquids are easily mixed.

To the cleaning liquid tank 5, a cleaning liquid hose 51 formed of an elastic material so as to be bendable is connected. One end of the cleaning liquid hose 51 is disposed inside the cleaning liquid tank 5, and the other end is connected to one inlet of the second three-way valve 34. Since the inside of the cleaning liquid tank 5 is pressurized by a compressed gas, the cleaning liquid tank 5 supplies the pressurized cleaning liquid F2 toward the second three-way valve 34 through the cleaning liquid hose 51.

The gas supply unit 6 is a supply source for supplying a gas F3, and stores the gas F3 in a compressed state. Examples of the gas F3 include an inert gas, such as nitrogen, and air. To the gas supply unit 6, a gas hose 61 formed of an elastic material so as to be bendable is connected. One end of the gas hose 61 is connected to the outlet of the gas supply unit 6, and the other end is connected to one inlet of the second three-way valve 34. The gas supply unit 6 supplies the pressurized gas F3 toward the second three-way valve 34 through the gas hose 61.

### 1-3. Operations of Coating Apparatus

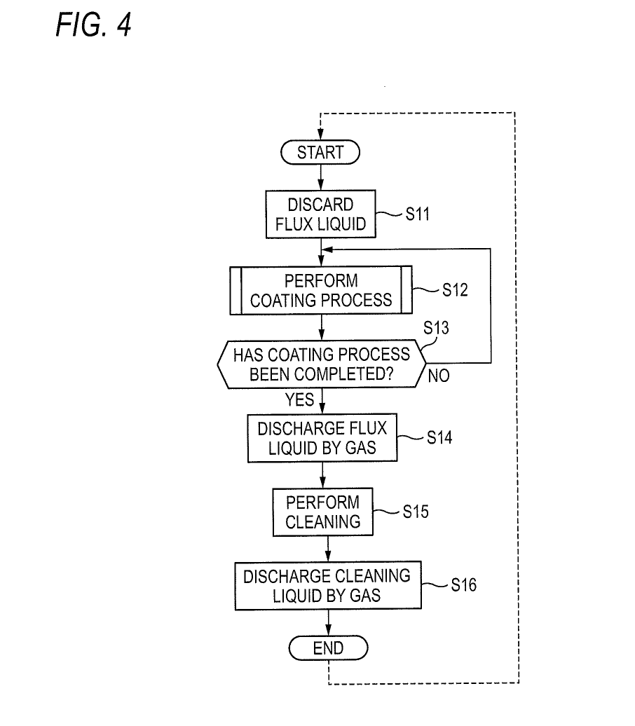

Now, operations of the coating apparatus 1 will be described. FIG. 4 is a view illustrating a flow of operations from activation of the coating apparatus 1 until stop of the coating apparatus.

In order to stably jet the flux liquid F1 in a coating process, prior to the coating process, first, in STEP S11, the flux liquid F1 is discarded from the nozzle 2 for a predetermined period (for example, 30 seconds).

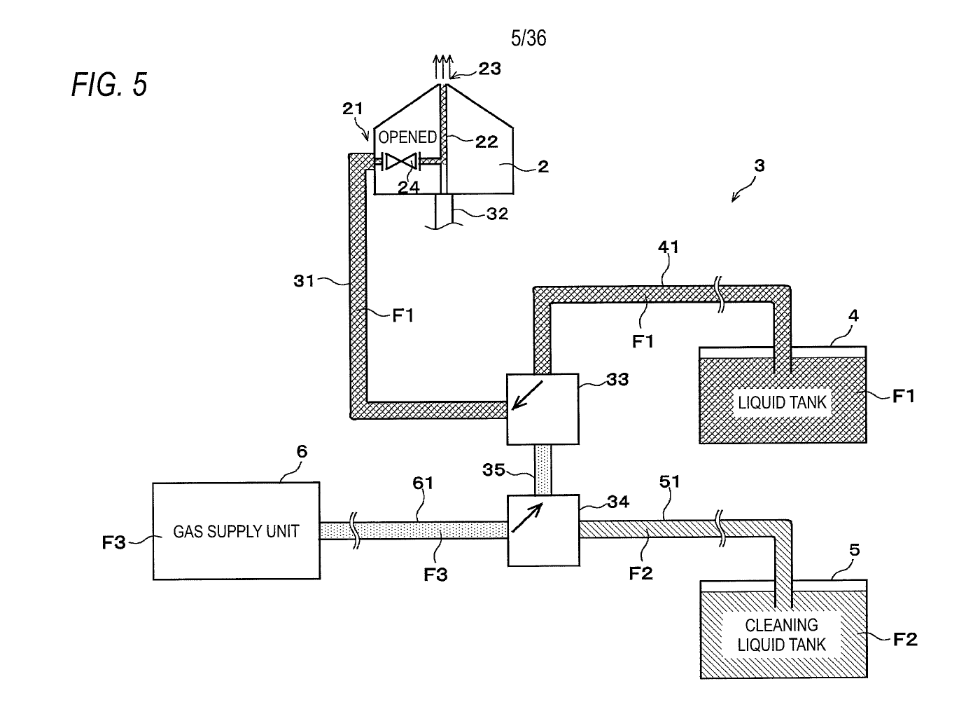

As shown in FIG. 5, the first three-way valve 33 opens a passage connecting the liquid hose 41 and the supply hose 31. In this state, the internal valve 24 opens the passage connecting the supply port 21 to the internal passage 22. As a result, the flux liquid F1 is supplied from the liquid hose 41 into the supply hose 31, whereby the supply hose 31 is filled with the flux liquid F1. Thereafter, the flux liquid F1 enters the internal passage 22 of the nozzle 2 through the supply port 21 and the internal valve 24, and is jetted from the nozzle opening 23 of the nozzle 2. After the predetermined period (for example, 30 seconds), the internal valve 24 closes the passage connecting the supply port 21 to the internal passage 22.

Subsequently, in STEP S12, a coating process on a printed circuit board 9 is performed according to control of the general control unit 10. In the coating process, the board transfer unit 12 transfers the printed circuit board 9 as a coating object while the nozzle moving unit 11 moves the nozzle 2, and the nozzle 2 applies the flux liquid on the object areas of the printed circuit board 9. Even in this coating process, as shown in FIG. 5, the first three-way valve 33 opens the passage connecting the liquid hose 41 and the supply hose 31 while the internal valve 24 opens the passage connecting the supply port 21 to the internal passage 22 only for a necessary period. As a result, the flux liquid F1 is jetted from the nozzle opening 23 of the nozzle 2.

This coating process of STEP S12 is repeated for every printed circuit board 9 which is a coating object (“No” in STEP S13).

If the coating process on every printed circuit board 9 which is a coating object is completed (“Yes” in STEP S13), subsequently, in STEP S14, the gas F3 is supplied to the supply hose 31, whereby the flux liquid F1 in the supply hose 31 is discharged.

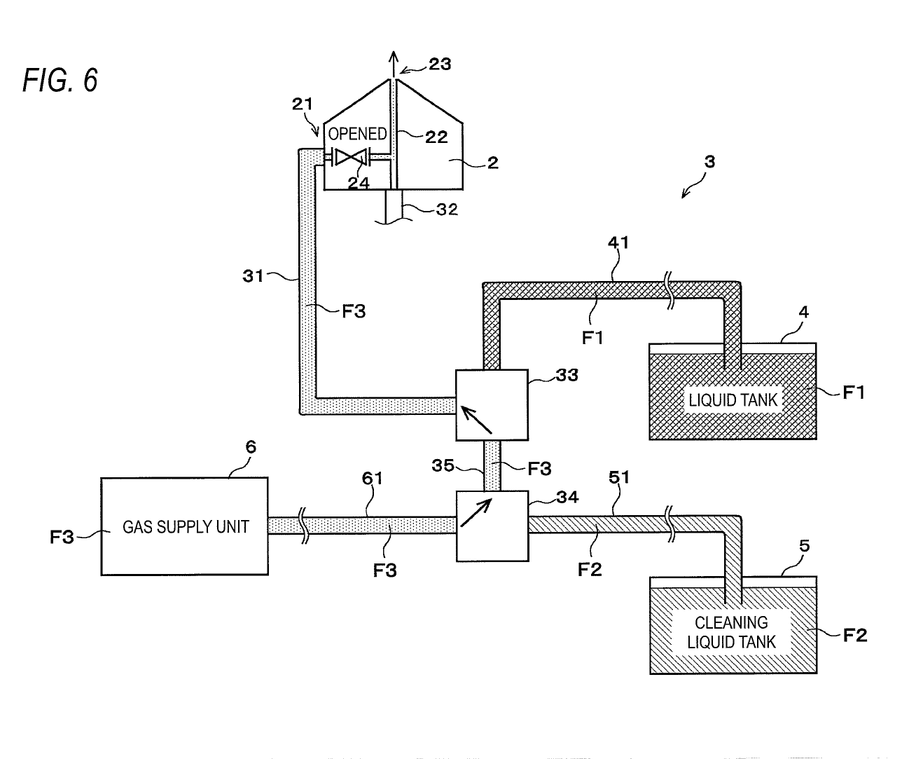

As shown in FIG. 6, the first three-way valve 33 closes the passage connecting the liquid hose 41 and the supply hose 31, and opens a passage connecting the coupling hose 35 and the supply hose 31. As a result, supply of the flux liquid F1 from the liquid hose 41 to the supply hose 31 is stopped. At the same time with this, the second three-way valve 34 opens a passage connecting the gas hose 61 and the coupling hose 35. In this state, the internal valve 24 opens the passage connecting the supply port 21 to the internal passage 22.

As a result, in a state where the flux liquid F1 is not supplied from the liquid hose 41 to the supply hose 31, the gas F3 is supplied from the gas hose 61 into the supply hose 31. The gas F3 enters the supply hose 31 and the internal passage 22 of the nozzle 2, and pushes the residual flux liquid F1 out of the supply hose 31 and the internal passage 22. As a result, the flux liquid F1 in the supply hose 31 and the internal passage 22 of the nozzle 2 are discharged from the nozzle opening 23 of the nozzle 2. After a predetermined period (for example, 30 seconds), the internal valve 24 closes the passage connecting the supply port 21 to the internal passage 22.

Subsequently, in STEP S15, the cleaning liquid F2 is supplied to the supply hose 31 from which the flux liquid F1 has been discharged, whereby the inside of the nozzle 2 is cleaned.

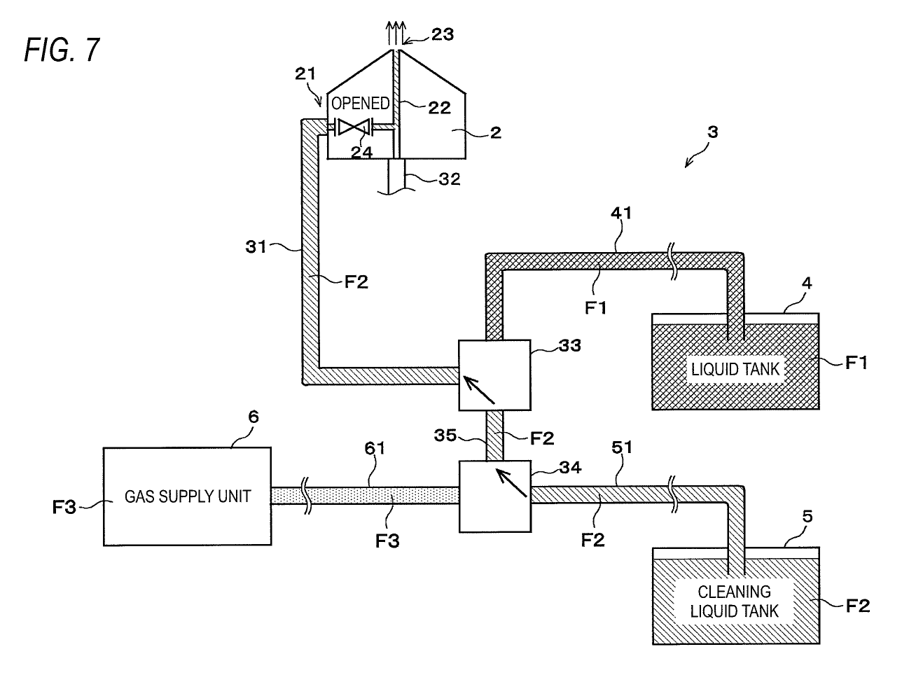

As shown in FIG. 7, the second three-way valve 34 closes the passage connecting the gas hose 61 and the coupling hose 35, and opens the passage connecting the cleaning liquid hose 51 and the coupling hose 35. In this state, the internal valve 24 opens the passage connecting the supply port 21 to the internal passage 22. As a result, supply of the gas F3 from the gas hose 61 into the supply hose 31 is stopped while the cleaning liquid F2 is supplied from the cleaning liquid hose 51 into the supply hose 31, whereby the supply hose 31 is filled with the cleaning liquid F2. Thereafter, the cleaning liquid F2 enters the internal passage 22 of the nozzle 2 through the supply port 21 and the internal valve 24, whereby the inside of the nozzle 2 is cleaned by the cleaning liquid F2.

As described above, in the coating apparatus 1, the gas F3 is supplied to the supply hose 31, thereby discharging the flux liquid F1 from the inside of the supply hose 31, and then the cleaning liquid F2 is supplied to the supply hose 31, thereby cleaning the inside of the nozzle 2. Therefore, it is possible to prevent the flux liquid F1 and the cleaning liquid F2 from being mixed inside the supply hose 31, and thus it is possible to clean the inside of the nozzle 2 by the cleaning liquid F2 consisting of correct components.

After a predetermined period (for example, 20 seconds), the internal valve 24 closes the passage connecting the supply port 21 to the internal passage 22. Since supply of the cleaning liquid F2 into the inside of the nozzle 2 continues for the predetermined period as described above, the inside of the nozzle 2 is sufficiently cleaned.

If cleaning of the inside of the nozzle 2 is completed, subsequently, in STEP S16, the gas F3 is supplied to the supply hose 31 again, whereby the cleaning liquid F2 in the supply hose 31 is discharged.

As shown in FIG. 6, the second three-way valve 34 closes the passage connecting the cleaning liquid hose 51 and the coupling hose 35, and opens the passage connecting the gas hose 61 and the coupling hose 35. In this state, the internal valve 24 opens the passage connecting the supply port 21 to the internal passage 22.

As a result, in a state where the cleaning liquid F2 is not supplied from the cleaning liquid hose 51 into the supply hose 31, the gas F3 is supplied from the gas hose 61 into the supply hose 31. The gas F3 enters the supply hose 31 and the internal passage 22 of the nozzle 2, and pushes the residual cleaning liquid F2 out of the supply hose 31 and the internal passage 22. As a result, the cleaning liquid F2 in the supply hose 31 and the internal passage 22 of the nozzle 2 are discharged from the nozzle opening 23 of the nozzle 2. After a predetermined period (for example, 30 seconds), the internal valve 24 closes the passage connecting the supply port 21 to the internal passage 22.

In this way, the cleaning liquid F2 is discharged from the inside of the supply hose 31 and the internal passage 22 of the nozzle 2. In this state, the coating apparatus 1 stops operating. Since the inside of the nozzle 2 is clean, during operation stop, the flux base material cannot remain and adhere to the inner side of the nozzle 2.

Thereafter, if the coating apparatus 1 starts to operate, the operations of FIG. 4 are repeated. In this case, first, in STEP S11, the flux liquid F1 is supplied to the supply hose 31 from which the cleaning liquid F2 has been discharged, and is discarded from the nozzle 2 for the predetermined period (for example, 30 seconds).

As shown in FIG. 5, the first three-way valve 33 closes the passage connecting the coupling hose 35 and the supply hose 31, and opens the passage connecting the liquid hose 41 and the supply hose 31. In this state, the internal valve 24 opens the passage connecting the supply port 21 to the internal passage 22. As a result, the flux liquid F1 is supplied from the liquid hose 41 into the supply hose 31, whereby the supply hose 31 is filled with the flux liquid F1. Thereafter, the flux liquid F1 enters the internal passage 22 of the nozzle 2 through the supply port 21 and the internal valve 24, and is jetted from the nozzle opening 23 of the nozzle 2. After the predetermined period (for example, 30 seconds), the internal valve 24 closes the passage connecting the supply port 21 to the internal passage 22.

As described above, in the coating apparatus 1, the gas F3 is supplied to the supply hose 31, whereby the cleaning liquid F2 in the supply hose 31 is discharged. Thereafter, the flux liquid F1 is supplied to the supply hose 31. Therefore, it is possible to prevent the flux liquid F1 and the cleaning liquid F2 from being mixed inside the supply hose 31. As a result, in the subsequent coating processes, it is possible to jet the flux liquid F1 of correct components from the nozzle 2, thereby applying the flux liquid on printed circuit boards.

As described above, the coating apparatus 1 of the present embodiment includes the supply hose 31 for conducting a fluid into the nozzle 2 for jetting the flux liquid F1. The liquid tank 4, the liquid hose 41, and the first three-way valve 33 supply the flux liquid F1 into the supply hose 31. Also, the cleaning liquid tank 5, the cleaning liquid hose 51, the second three-way valve 34, the coupling hose 35, and the first three-way valve 33 supply the cleaning liquid F2 into the supply hose. Further, the gas supply unit 6, the gas hose 61, the second three-way valve 34, the coupling hose 35, and the first three-way valve 33 supply the gas F3 into the supply hose 31. After a coating process, supply of the flux liquid F1 into the supply hose 31 is stopped. In this state, the gas F3 is supplied to the supply hose 31, whereby the flux liquid F1 in the supply hose 31 is discharged. Thereafter, the cleaning liquid F2 is supplied to the supply hose 31 from which the flux liquid F1 has been discharged, whereby the inside of the nozzle 2 is cleaned. Therefore, it is possible to prevent the flux liquid F1 and the cleaning liquid F2 from being mixed inside the supply hose 31, and thus it is possible to clean the inside of the nozzle 2 by the cleaning liquid F2 consisting of correct components. As a result, it is possible to effectively clean the inside of the nozzle.

Also, after cleaning of the inside of the nozzle 2, supply of the cleaning liquid F2 into the supply hose 31 is stopped. In this state, the gas F3 is supplied to the supply hose 31, whereby the cleaning liquid F2 in the supply hose 31 is discharged. Thereafter, the flux liquid F1 is supplied to the supply hose 31 from which the cleaning liquid F2 has been discharged. As a result, it is possible to prevent the flux liquid F1 and the cleaning liquid F2 from being mixed inside the supply hose 31, and thus it is possible to jet the flux liquid F1 consisting of correct components from the nozzle 2.

### 2. Second Embodiment

Now, the second embodiment will be described. The configuration and operations of a coating apparatus 1 of the second embodiment are almost similar to those of the first embodiment, and thus differences from the first embodiment will be mainly described below.

In the first embodiment, in a case of supplying the gas F3 into the supply hose 31, thereby discharging a liquid (the flux liquid F1 or the cleaning liquid F2) from the inside of the supply hose 31, the liquid is discharged from the nozzle opening 23 of nozzle 2. Since the nozzle 2 is a spray nozzle, the opening size of the nozzle 2 is relatively small, and thus a flow of fluid which the nozzle 2 can eject is small. For this reason, even if the gas F3 is supplied to push a liquid out of the supply hose 31, it takes a relatively long time to discharge that liquid from the nozzle opening 23. Also, it is impossible to completely discharge the liquid from the supply hose 31, and thus there is a possibility that a portion of the liquid may remain inside supply hose 31. Especially, it is often to suspend the supply hose 31 directed to the nozzle 2 for jetting a liquid upward, in a U shape, and use the supply hose in that state. In this case of suspending the supply hose 31 in a U shape and using the supply hose in that state, there is a possibility that a liquid may remain at a bent portion which is the lowest portion of the supply hose 31.

In order to cope with this, in the coating apparatus 1 of the second embodiment, a discharge pipe having an opening size larger than that of the nozzle 2 is provided such that a liquid in the supply hose 31 is discharged through the discharge pipe.

### 2-1. Configuration of Fluid Supply Unit

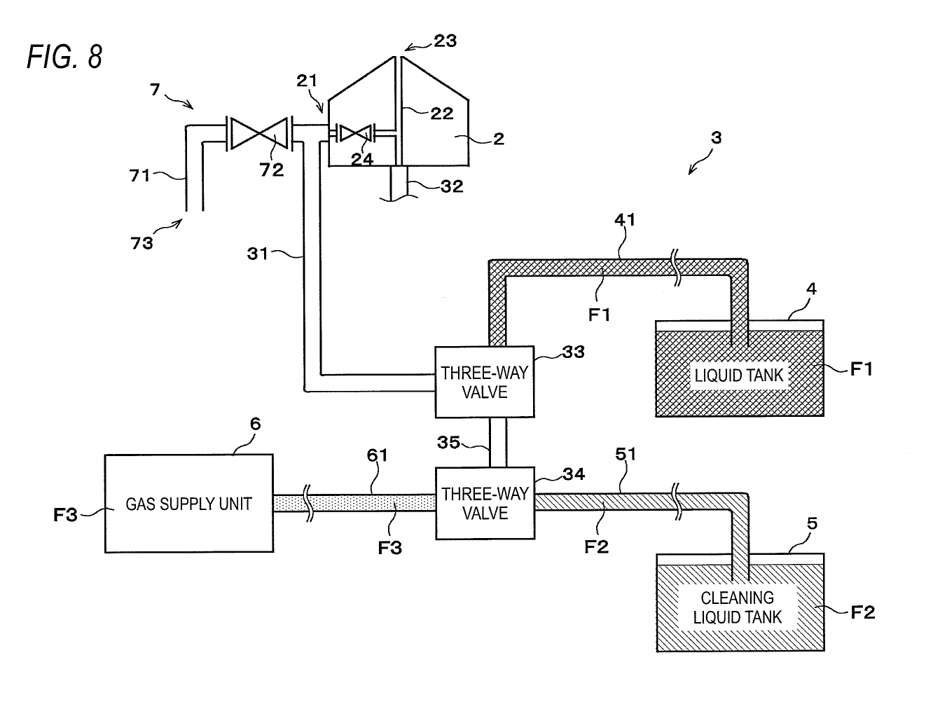

FIG. 8 is a view illustrating a configuration of a fluid supply unit 3 of the second embodiment together with the nozzle 2. The fluid supply unit 3 of the second embodiment further includes a discharging unit 7 for discharging a fluid contained in the supply hose 31, in addition to the components of the first embodiment.

The discharging unit 7 includes a discharge pipe 71, and a discharge valve 72 which is a two-way valve. One end of the discharge pipe 71 is connected to the supply hose 31 in the vicinity of a portion of the supply hose 31 connected to the nozzle 2, through the discharge valve 72. Also, the other end of the discharge pipe 71 is opened as an outlet 73. Therefore, the discharge pipe 71 conducts a liquid contained in the supply hose 31, to the outlet 73.

The discharge valve 72 opens and closes a passage connecting the supply hose 31 and the discharge pipe 71, according to control of the general control unit 10. If the discharge valve 72 opens that passage, a fluid in the supply hose 31 enters the discharge pipe 71 by the internal pressures of the supply hose 31. The liquid entering the discharge pipe 71 passes through the discharge pipe 71 and is discharged from the outlet 73 to the outside.

The opening size of the discharge pipe 71 (the inside diameter of the outlet 73) is larger than the opening size of the nozzle 2 (the inside diameter of the nozzle opening 23). Therefore, a flow of fluid which the discharge pipe 71 can discharge is sufficiently larger than a flow of fluid which the nozzle 2 can eject. For example, the opening size (diameter) of the nozzle 2 is about 0.1 mm; whereas the opening size (diameter) of the discharge pipe 71 is about 3 mm. Since a flow of fluid which can flow through an opening is proportional to the square of the diameter of the opening, the flow of fluid which the discharge pipe 71 can discharge becomes about 900 times the flow of fluid which the nozzle 2 can eject.

### 2-2. Operations of Coating Apparatus

Now, operations of the coating apparatus 1 of the second embodiment will be described with reference to FIG. 4. First, in STEP S11, the flux liquid F1 is discarded from the nozzle 2 for the predetermined period (for example, 30 seconds).

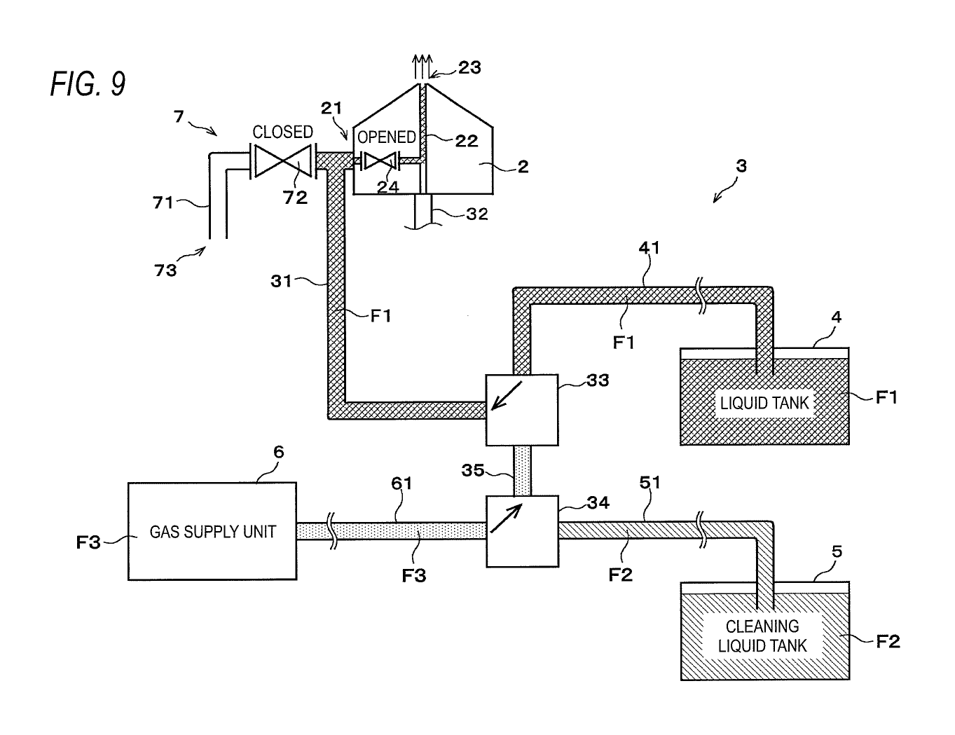

As shown in FIG. 9, the first three-way valve 33 opens the passage connecting the liquid hose 41 and the supply hose 31. At the same time with this, the discharge valve 72 closes the passage connecting the supply hose 31 to the discharge pipe 71, and the internal valve 24 opens the passage connecting the supply port 21 to the internal passage 22.

As a result, the flux liquid F1 is supplied from the liquid hose 41 into the supply hose 31, whereby the supply hose 31 is filled with the flux liquid F1. Thereafter, the flux liquid F1 enters the internal passage 22 of the nozzle 2 through the supply port 21 and the internal valve 24, and is jetted from the nozzle opening 23 of the nozzle 2.

Subsequently, in STEP S12, a coating process on a printed circuit board 9 is performed according to control of the general control unit 10. Even in this coating process, as shown in FIG. 9, the flux liquid F1 is jetted from the nozzle opening 23 of the nozzle 2.

If the coating process is completed (“Yes” in STEP S13), subsequently, in STEP S14, the gas F3 is supplied to the supply hose 31, whereby the flux liquid F1 in the supply hose 31 is discharged.

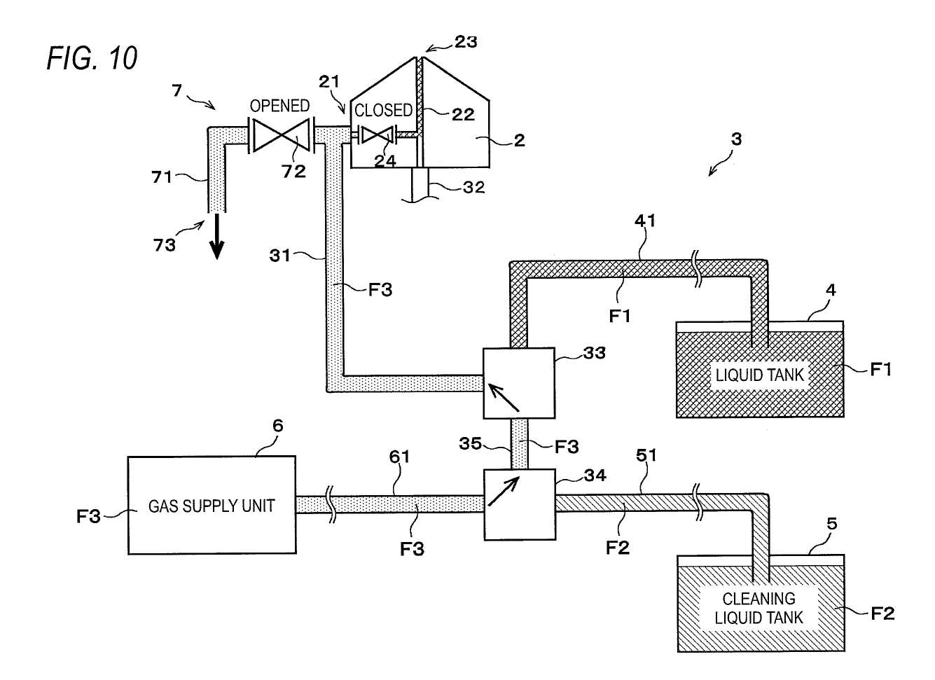

As shown in FIG. 10, the first three-way valve 33 opens the passage connecting the coupling hose 35 and the supply hose 31, and the second three-way valve 34 opens the passage connecting the gas hose 61 and the coupling hose 35. At the same time with this, the internal valve 24 closes the passage connecting the supply port 21 to the internal passage 22, and the discharge pipe 71 opens the passage connecting the supply hose 31 to the discharge pipe 71. As a result, in a state where the flux liquid F1 is not supplied from the liquid hose 41 to the supply hose 31, the gas F3 is supplied from the gas hose 61 into the supply hose 31.

The gas F3 enters the supply hose 31, and pushes the flux liquid F1 contained in the supply hose, to the discharge pipe 71 through the discharge valve 72. As a result, the flux liquid F1 in the supply hose 31 passes through the discharge pipe 71 and is discharged from the outlet 73.

Since the flow of fluid which the discharge pipe 71 can discharge is large, a large amount of gas F3 entering the supply hose 31 pushes the flux liquid F1 contained in the supply hose 31 into the discharge pipe 71 at once. Therefore, it is possible to discharge the flux liquid F1 in a relatively short time, and it is possible to prevent the flux liquid F1 from remaining inside the supply hose 31.

Subsequently, in STEP S15, the cleaning liquid F2 is supplied to the supply hose 31 from which the flux liquid F1 has been discharged, whereby the inside of the nozzle 2 is cleaned.

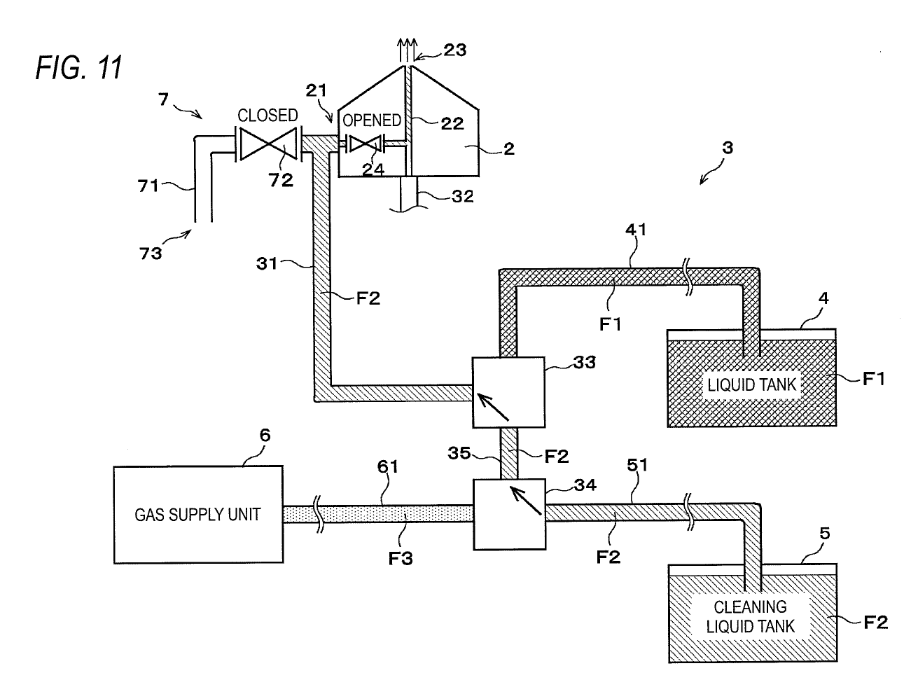

As shown in FIG. 11, the second three-way valve 34 opens the passage connecting the cleaning liquid hose 51 and the coupling hose 35. At the same time with this, the discharge valve 72 closes the passage connecting the supply hose 31 to the discharge pipe 71, and the internal valve 24 opens the passage connecting the supply port 21 to the internal passage 22. As a result, the cleaning liquid F2 is supplied from the cleaning liquid hose 51 into the supply hose 31, whereby the supply hose 31 is filled with the cleaning liquid F2. At this moment, since there is no residual flux liquid F1 inside the supply hose 31, it is possible to prevent the flux liquid F1 and the cleaning liquid F2 from being mixed inside the supply hose 31.

Thereafter, the cleaning liquid F2 enters the internal passage 22 of the nozzle 2 through the supply port 21 and the internal valve 24, whereby the inside of the nozzle 2 is cleaned by the cleaning liquid F2. In a case of discharging the flux liquid F1 in STEP S14, since the internal valve 24 closes the passage, a small amount of flux liquid F1 remains in the internal passage 22 of the nozzle 2. However, the amount of residual flux liquid F1 is a small amount which the nozzle 2 can rapidly eject. Therefore, if the cleaning liquid F2 enters the internal passage 22 of the nozzle 2, the flux liquid F1 in the internal passage 22 of the nozzle 2 is quickly discharged from the nozzle opening 23, whereby the liquid in the internal passage 22 of the nozzle 2 is completely exchanged with the cleaning liquid F2. Therefore, it is possible to clean the inside of the nozzle 2 by the cleaning liquid F2 consisting of correct components. This supply of the cleaning liquid F2 continues for the predetermined period (for example, 20 seconds), and thus the inside of the nozzle 2 is sufficiently cleaned.

If cleaning of the inside of the nozzle 2 is completed, subsequently, in STEP S16, the gas F3 is supplied to the supply hose 31 again, whereby the cleaning liquid F2 in the supply hose 31 is discharged.

As shown in FIG. 10, the second three-way valve 34 opens the passage connecting the gas hose 61 and the coupling hose 35. At the same time with this, the internal valve 24 closes the passage connecting the supply port 21 to the internal passage 22, and the discharge pipe 71 opens the passage connecting the supply hose 31 to the discharge pipe 71. As a result, in a state where the cleaning liquid F2 is not supplied from the cleaning liquid hose 51 into the supply hose 31, the gas F3 is supplied from the gas hose 61 into the supply hose 31.

The gas F3 enters the supply hose 31, and pushes the cleaning liquid F2 contained in the supply hose 31 into the discharge pipe 71 through the discharge valve 72. As a result, the cleaning liquid F2 in the supply hose 31 passes 73 through the discharge pipe 71 and is discharged from the outlet.

Since the flow of fluid which the discharge pipe 71 can discharge is large, a large amount of gas F3 entering the supply hose 31 pushes the cleaning liquid F2 contained in the supply hose 31 into the discharge pipe 71 at once. Therefore, it is possible to discharge the cleaning liquid F2 in a relatively short time, and it is possible to prevent the cleaning liquid F2 from remaining inside the supply hose 31.

In this way, the cleaning liquid F2 is discharged from the inside of the supply hose 31. In this state, the coating apparatus 1 stops operating. In a case of discharging the cleaning liquid F2 in STEP S16, since the internal valve 24 closes the passage, a small amount of cleaning liquid F2 remains in the internal passage 22 of the nozzle 2. However, since the cleaning liquid F2 does not contain the flux base material, even if the cleaning liquid F2 vaporizes during stop of the coating apparatus 1, the flux base material cannot adhere to the inner side of the nozzle 2.

Thereafter, if the coating apparatus 1 starts to operate, the operations of FIG. 4 are repeated. In this case, first, in STEP S11, the flux liquid F1 is supplied to the supply hose 31 from which the cleaning liquid F2 has been discharged, and is discarded from the nozzle 2 for the predetermined period (for example, 30 seconds).

As shown in FIG. 9, the first three-way valve 33 opens the passage connecting the liquid hose 41 and the supply hose 31. At the same time with this, the discharge valve 72 closes the passage connecting the supply hose 31 to the discharge pipe 71, and the internal valve 24 opens the passage connecting the supply port 21 to the internal passage 22. As a result, the flux liquid F1 is supplied from the liquid hose 41 into the supply hose 31, whereby the supply hose 31 is filled with the flux liquid F1. At this moment, since there is no residual cleaning liquid F2 inside the supply hose 31, it is possible to prevent the flux liquid F1 and the cleaning liquid F2 from being mixed inside the supply hose 31.

Thereafter, the flux liquid F1 enters the internal passage 22 of the nozzle 2 through the supply port 21 and the internal valve 24, and is jetted from the nozzle opening 23 of the nozzle 2. The amount of residual cleaning liquid F2 in the internal passage 22 of the nozzle 2 is a small amount which the nozzle 2 can rapidly eject. Therefore, if the flux liquid F1 enters the internal passage 22 of the nozzle 2, the cleaning liquid F2 in the internal passage 22 of the nozzle 2 is quickly discharged from the nozzle opening 23, whereby the liquid in the internal passage 22 of the nozzle 2 is completely exchanged with the flux liquid F1. As a result, in the subsequent coating processes, it is possible to jet the flux liquid F1 of correct components from the nozzle 2.

As described above, the coating apparatus 1 of the second embodiment includes the discharge pipe 71 for conducting a fluid contained in the supply hose 31 into the outlet 73, and discharges the fluid contained in the supply hose 31 through the discharge pipe 71. The opening size of the discharge pipe 71 is sufficiently larger than the opening size of the nozzle 2. Since a fluid in the supply hose 31 is discharged through the discharge pipe 71 having a large opening size as described above, it is possible to discharge a fluid in a relatively short time, and it is possible to prevent a liquid from remaining inside the supply hose 31.

### 3. Other Embodiments

Now, other embodiments will be described. All forms including the above described embodiments and the following embodiments to be described below can be appropriately combined.

### 3-1. Cleaning of Outside of Nozzle

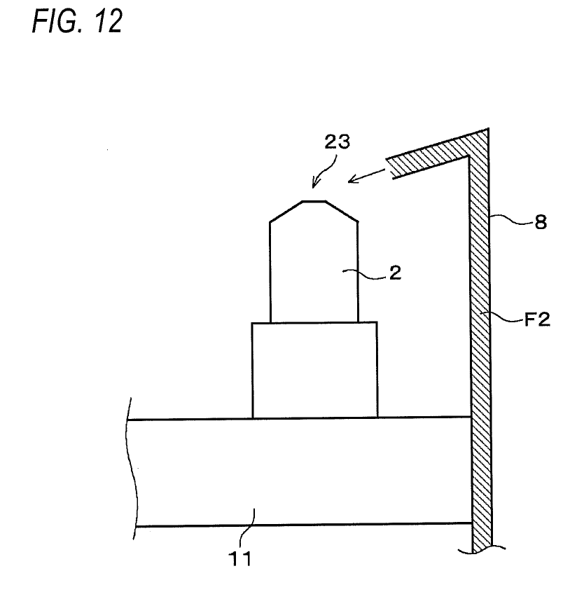

According to the above described embodiments, in a case of cleaning the nozzle 2, the inside of the nozzle is cleaned. However, in addition to the inside of the nozzle 2, the outside of the nozzle 2 may be cleaned. For example, as shown in FIG. 12, a cleaning nozzle 8 for ejecting the cleaning liquid F2 onto the outside of the nozzle 2 is provided. In this case, in order to clean the nozzle 2, in addition to an operation of cleaning the inside of the nozzle 2 in the same way as those in the above described embodiments, the cleaning liquid F2 is ejected from the cleaning nozzle 8 toward the vicinity of the nozzle opening 23 of the nozzle 2. As a result, together with the inside of the nozzle 2, the outside of the nozzle 2 is cleaned, and thus it is possible to prevent the flux base material from adhering to either the inner side or the outer side of the nozzle 2.

### 3-2. Check Valve

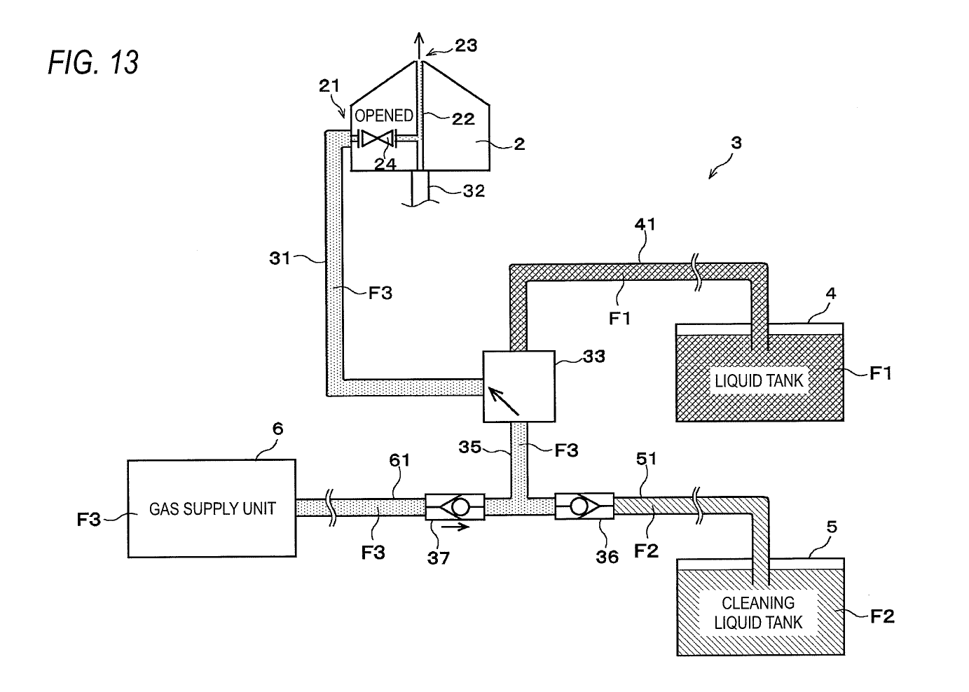

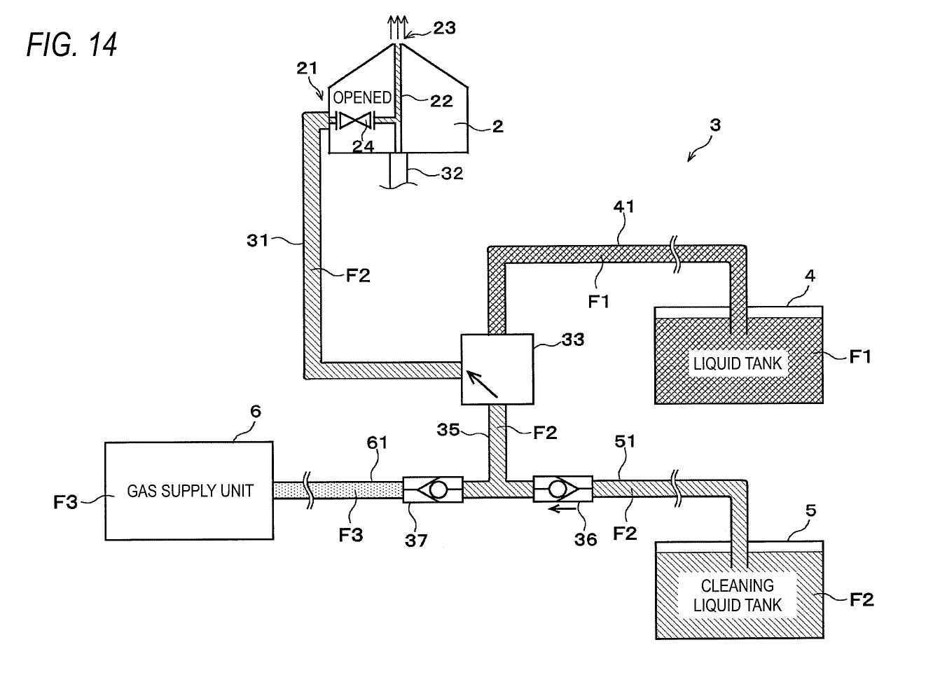

Also, in place of the second three-way valve 34 which is used in the above described embodiments, two check valves may be provided. FIGS. 13 and 14 are views illustrating a configuration of a fluid supply unit 3 including two check valves 36 and 37 in place of the second three-way valve 34.

The first check valve 36 is provided on the passage connecting the cleaning liquid hose 51 and the coupling hose 35. The first check valve 36 prevents a fluid from flowing back from the coupling hose 35 into the cleaning liquid hose 51. Also, the second check valve 37 is provided on the passage connecting the gas hose 61 and the coupling hose 35. The second check valve 37 prevents a fluid from flowing back from the coupling hose 35 into the gas hose 61.

As shown in FIG. 13, in a case of supplying the gas F3 into the supply hose 31, the gas supply unit 6 supplies the pressurized gas F3 toward the second check valve 37 through the gas hose 61. Meanwhile, pressurizing of the inside of the cleaning liquid tank 5 is stopped, whereby the cleaning liquid tank 5 stops supply of the pressurized cleaning liquid F2. As a result, the gas F3 passes through the second check valve 37, and is supplied to the supply hose 31 through the coupling hose 35 and the first three-way valve 33. In this case, due to the action of the first check valve 36, the gas F3 is prevented from entering the cleaning liquid hose 51.

Also, as shown in FIG. 14, in a case of supplying the cleaning liquid F2 into the supply hose 31, the cleaning liquid tank 5 supplies the pressurized cleaning liquid F2 toward the first check valve 36 through the cleaning liquid hose 51. Meanwhile, the gas supply unit 6 stops supply of the pressurized gas F3. As a result, the cleaning liquid F2 passes through the first check valve 36, and is supplied to the supply hose 31 through the coupling hose 35 and the first three-way valve 33. At this moment, due to the action of the second check valve 37, the cleaning liquid F2 is prevented from entering the gas hose 61.

As described above, by providing the two check valves 36 and 37 are provided in place of the second three-way valve 34, it is possible to implement the same functions as those of the above described embodiments at relatively low cost. Also, similarly, in place of the first three-way valve 33, two check valves may be provided.

### 3-3. Bubble Cleaning

Also, in the case of providing the two check valves 36 and 37 as shown in FIGS. 13 and 14, in order to clean the inside of the nozzle 2, both of the cleaning liquid tank 5 and the gas supply unit 6 may supply pressurized fluids at the same time. According to this configuration, since the cleaning liquid F2 which the cleaning liquid tank 5 supplies and the gas F3 which the gas supply unit 6 supplies are mixed in the coupling hose 35, a cleaning liquid containing bubbles is supplied to the supply hose 31. As a result, it is possible to clean the inside of the nozzle 2 with the cleaning liquid containing bubbles, and thus it is possible to improve the effect of cleaning by the principle of bubble cleaning.

### 3-4. Other Modifications

In the above described embodiments, as a conducting pipe for conducting a fluid such as the flux liquid into the nozzle 2, the supply hose 31 is formed of an elastic material. However, the conducting pipe may be formed of any other material such as a metal.

Also, in the above described embodiments, the cleaning liquid is a liquid identical to the diluent of the flux liquid. However, as the cleaning liquid, a liquid different from the diluent of the flux liquid may be used.

Also, in the above described embodiments, the nozzle 2 is a spray nozzle for spraying the flux liquid. However, the nozzle 2 may be any nozzle for jetting the flux liquid without atomizing the flux liquid.

Also, in the above described embodiments, operations of all of the three-way valves 33 and 34 and the two-way valves 72 and 24 are controlled by the general control unit 10. However, some of them may be manually operated by a user.

Now, third and fourth embodiments of the present invention will be described with reference to the drawings.

### 4. Third Embodiment

### 4-1. Outline of Coating Apparatus

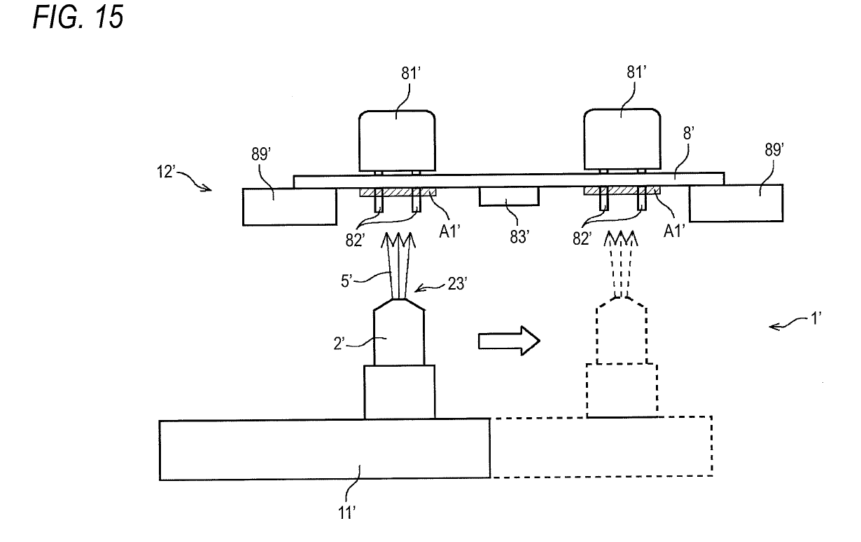

FIG. 15 is a view illustrating an outline of a coating apparatus 1′ according to the present embodiment. In a process of manufacturing printed circuit boards 8′, the coating apparatus 1′ performs a coating process of applying a flux liquid 5′ on each printed circuit board 8′, as a pre-process of soldering. The coating apparatus 1′ has a function of transferring a printed circuit board 8′ which is a coating object and applying the flux liquid on the lower surface of the corresponding printed circuit board 8′.

The coating apparatus 1′ includes a board transfer unit 12′, which moves each printed circuit board 8′ mounted on a palette 89′, substantially in a horizontal direction. In a coating process, first, the coating apparatus 1′ moves a printed circuit board 8′ received from an upstream side apparatus, to a predetermined processing position, and stops the printed circuit board 8′ at the processing position, by the board transfer unit 12′. Thereafter, the coating apparatus 1′ applies the flux liquid 5′ on the lower surface of the printed circuit board 8′ positioned at the processing position. If applying of the flux liquid 5′ is completed, the coating apparatus 1′ transfers the printed circuit board 8′ to a downstream side apparatus by the board transfer unit 12′.

On the printed circuit board 8′, there are electronic components 81′ to be soldered. Leads 82′ of the electronic components 81′ pass through through-holes of the printed circuit board 8′ and protrude downward from the printed circuit board 8′. These leads 82′ of the electronic components 81′ become objects of soldering of a post-process.

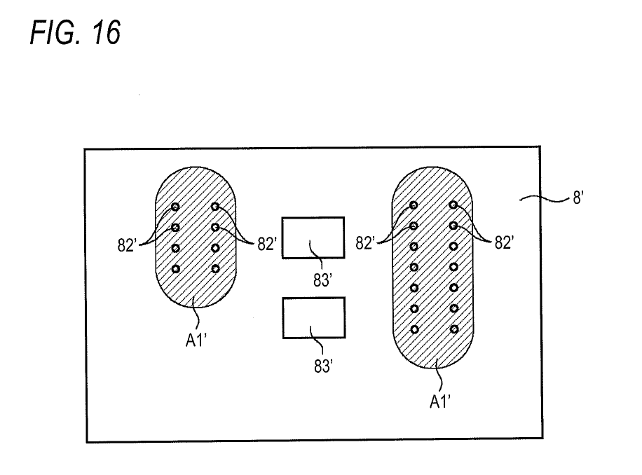

FIG. 16 is a view illustrating an example of the lower surface of a printed circuit board 8′. As shown in FIG. 16, the coating apparatus 1′ selectively applies the flux liquid 5′ only on object areas A1′ around the leads 82′ on the lower surface of each printed circuit board 8′. As shown in FIG. 16, in the outer area from the object areas A1′ on the lower surface of each printed circuit board 8′, coating prohibition components 83′ which are prohibited from being coated with the flux liquid 5′ may be disposed.

Referring to FIG. 15 again, the coating apparatus 1′ includes a nozzle 2′ for jetting the flux liquid 5′, and a nozzle moving unit 11′ for moving the nozzle 2′.

The nozzle 2′ is a spray nozzle for spraying the flux liquid 5′. In a coating process, the nozzle 2′ jets the flux liquid 5′ upward from a nozzle opening 23′ formed in the upper portion of the nozzle, thereby applying the flux liquid 5′ on the lower surface of a printed circuit board 8′ disposed at the processing position. A range into which the nozzle 2′ jets the flux liquid 5′ is narrower than that of a general spray nozzle, and the nozzle 2′ applies the flux liquid 5′ on relatively narrow ranges of each printed circuit board 8′.

The nozzle moving unit 11′ is, for example, a Cartesian coordinate robot, and moves the nozzle 2′ in two axis directions along a substantially horizontal direction. In a coating process, the nozzle moving unit 11′ moves the nozzle 2′ along the object areas A1′ of each printed circuit board 8′. As a result, the flux liquid 5′ is prevented from being applied on the outer area from the object areas A1′ on each printed circuit board 8′.

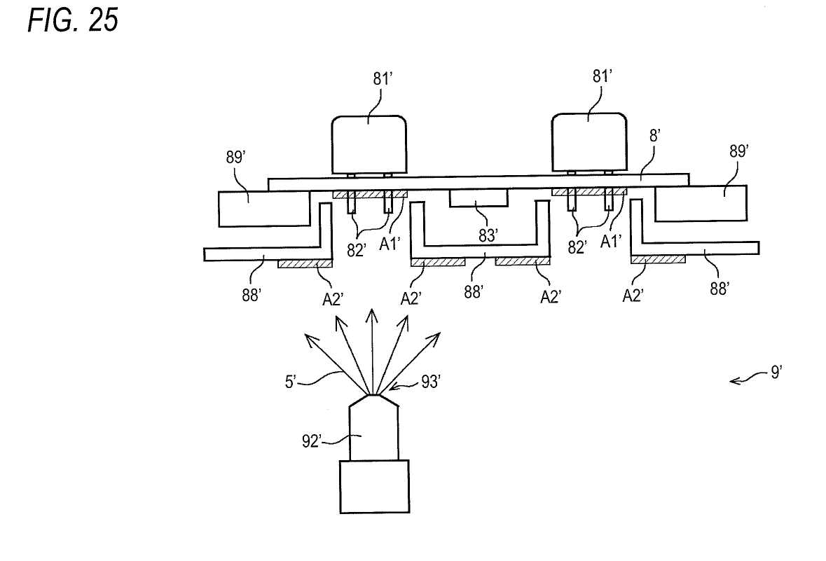

According to this method of applying the flux liquid 5′, the coating apparatus 1′ accurately applies the flux liquid 5′ only on the object areas A1′ of each printed circuit board 8′, without interposing the cover member 88′ (see FIG. 25) for covering some portions of each printed circuit board 8′ (such as the outer area from the object areas A1′).

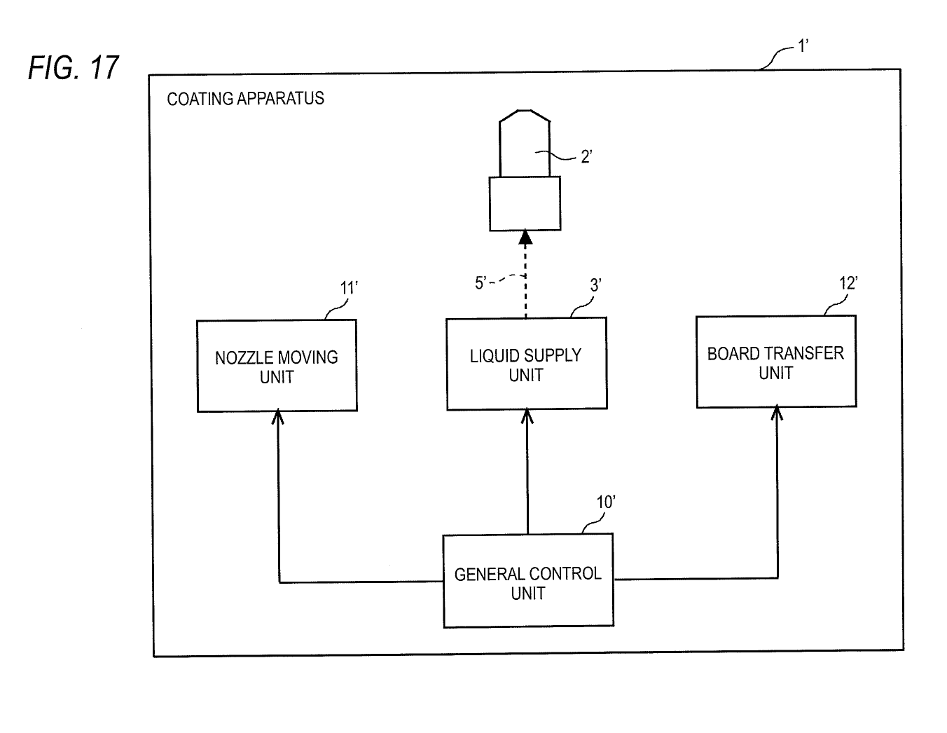

FIG. 17 is a block diagram illustrating a rough configuration of the coating apparatus V. The coating apparatus 1′ includes a general control unit 10′ and a liquid supply unit 3′, in addition to the board transfer unit 12′, the nozzle 2′, and the nozzle moving unit 11′ described above.

The general control unit 10′ is, for example, a programmable logic controller (PLC). The general control unit 10′ performs processes according to programs, thereby generally controlling operations of the board transfer unit 12′, the nozzle moving unit 11′, and the liquid supply unit 3′.

The liquid supply unit 3′ supplies the flux liquid 5′ into the nozzle 2′. The liquid supply unit 3′ supplies the pressurized flux liquid 5′ into the nozzle 2′, whereby the flux liquid 5′ is jetted from the nozzle 2′.

The pressure of the flux liquid 5′ which the liquid supply unit 3′ supplies into the nozzle 2′ defines the range into which the nozzle 2′ jets the flux liquid 5′. For this reason, in the coating apparatus 1′ using a coating method which does not need interposing of a cover member as described above, in order to stabilize the range into which the nozzle 2′ jets the flux liquid 5′, the pressure of the flux liquid 5′ which the liquid supply unit 3′ supplies into the nozzle 2′ is maintained substantially at a constant value. Hereinafter, a technology for maintaining the pressure the flux liquid 5′ substantially at the constant value as described above will be described in detail.

### 4-2. Liquid Supply Unit

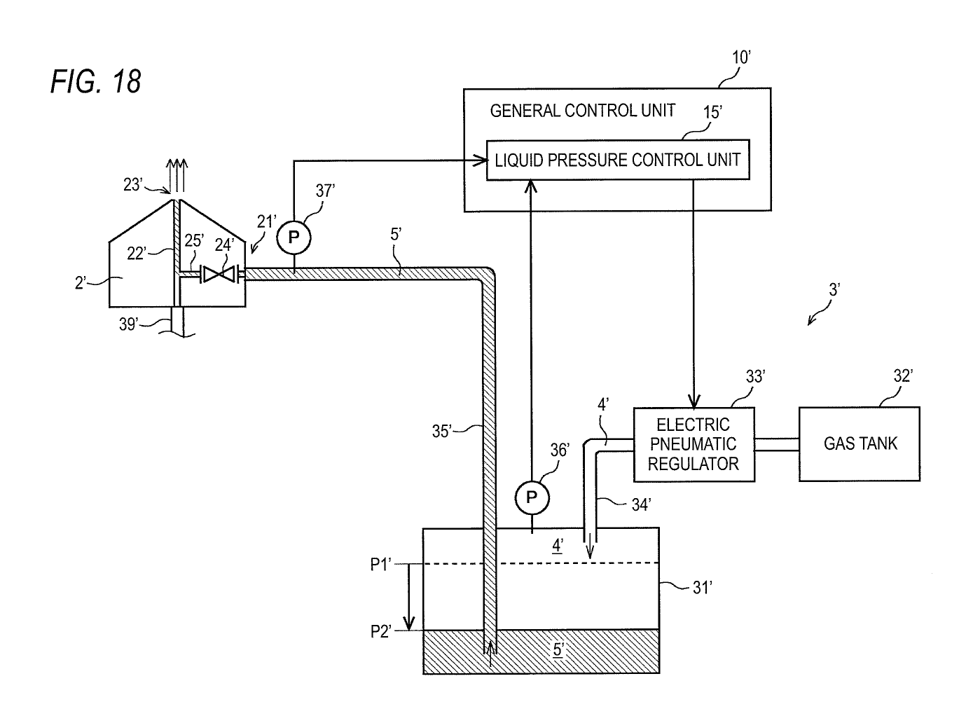

FIG. 18 is a view illustrating a configuration of the liquid supply unit 3′ together with related components (the nozzle 2′ and the general control unit 10′).

The liquid supply unit 3′ includes a liquid tank 31′ which is a liquid container for storing the flux liquid 5′, and a supply hose 35′ which is a conducting pipe for conducting the flux liquid 5′ from the liquid tank 31′ into the nozzle 2′.

The liquid tank 31′ is a supply source of the flux liquid 5′, and stores the flux liquid 5′ therein. The flux liquid 5′ is, for example, a liquid obtained by diluting a flux base material such as rosin with a diluent such as isopropyl alcohol (IPA).

Also, the supply hose 35′ is a hollow tube formed of an elastic material such as rubber or vinyl so as to be bendable. One end of the supply hose 35′ is connected to a supply port 21′ of the nozzle 2′, and the other end of the supply hose 35′ is inserted into the flux liquid 5′ stored in the liquid tank 31′.

Also, the liquid supply unit 3′ includes a gas tank 32′ for storing gas 4′, an electric pneumatic regulator 33′ for regulating the pressure of the gas 4′, and a gas hose 34′ for conducting the gas 4′ into the liquid tank 31′. The gas tank 32′, the electric pneumatic regulator 33′, and the gas hose 34′ supply the gas 4′ into the liquid tank 31′, thereby pressurizing the inside of the liquid tank 31′.

The gas tank 32′ is a supply source of the gas 4′, and stores the gas 4′ compressed by pressurization. Examples of the gas 4′ include an inert gas, such as nitrogen, and air. The gas tank 32′ supplies the pressurized gas 4′ into the liquid tank 31′ through the electric pneumatic regulator 33′ and the gas hose 34′.

The electric pneumatic regulator 33′ is a regulating unit for regulating the pressure of the gas 4′ which is supplied from the gas tank 32′ into the liquid tank 31′. The electric pneumatic regulator 33′ includes a plurality of solenoid valves for changing a flow of gas 4′. The electric pneumatic regulator 33′ regulates the pressure of the gas 4′ to be supplied to the liquid tank 31′ such that the pressure becomes an instruction value represented by a control signal received from the general control unit 10′.

The gas hose 34′ is a conducting pipe for conducting the gas 4′ having the pressure regulated by the electric pneumatic regulator 33′ into the liquid tank 31′. One end of the gas hose 34′ is connected to the electric pneumatic regulator 33′, and the other end of the gas hose 34′ is disposed above the liquid level of the flux liquid 5′ in the liquid tank 31′. Therefore, the gas 4′ conducted from the gas tank 32′ into the gas hose 34′ is supplied to an area above the liquid level of the flux liquid 5′ in the liquid tank 31′.

Since the liquid tank 31′ is sealed, if the gas 4′ is supplied to the liquid tank 31′ as described above, the inside of the liquid tank 31′ is pressurized. The gas 4′ in the liquid tank 31′ is pressurized to the pressure regulated by the electric pneumatic regulator 33′. If the gas 4′ in the liquid tank 31′ is pressurized, the gas 4′ presses the liquid level of the flux liquid 5′ stored in the liquid tank 31′. As a result, the pressed flux liquid 5′ enters the supply hose 35′, and is sent from the liquid tank 31′ through the supply hose 35′. Thereafter, the pressurized flux liquid 5′ moves through the supply hose 35′ and is supplied into the supply port 21′ of the nozzle 2′.

The nozzle 2′ includes a nozzle valve 24′ which is a two-way valve. The nozzle valve 24′ opens and closes a supply passage 25′ connecting the supply port 21′ of the nozzle 2′ and an internal passage 22′ of the nozzle 2′. The supply passage 25′ is a passage for conducting the flux liquid 5′ contained in the supply hose 35′ into the nozzle 2′. If the nozzle valve 24′ opens the supply passage 25′, the pressurized flux liquid 5′ in the supply hose 35′ enters the internal passage 22′ of the nozzle 2′. The flux liquid 5′ entering the internal passage 22′ of the nozzle 2′ is pressurized by the gas which is supplied from a hose 39′ connected to the nozzle 2′, thereby atomizing. As a result, the nozzle 2′ sprays the flux liquid 5′ from the nozzle opening 23′.

Therefore, if the nozzle valve 24′ opens the supply passage 25′, the flux liquid 5′ is jetted from the nozzle 2′, and if the nozzle valve 24′ closes the supply passage 25′, jetting of the flux liquid 5′ from the nozzle 2′ is stopped. This operation of the nozzle valve 24′ is controlled by the general control unit 10′. If the general control unit 10′ switches a coating signal to an ON state and transits the coating signal to the nozzle valve 24′, the nozzle valve 24′ opens the supply passage 25′. Meanwhile, if the general control unit 10′ switches the coating signal to an OFF state, the nozzle valve 24′ closes the supply passage 25′.

Also, the liquid supply unit 3′ includes a gas pressure sensor 36′ which is a manometer for detecting the pressure of the gas 4′ in the liquid tank 31′, and a liquid pressure sensor 37′ which is a manometer for detecting the pressure of the flux liquid 5′ in the supply hose 35′. The gas pressure sensor 36′ and the liquid pressure sensor 37′ output signals representing their detection values, to the general control unit 10′.

The general control unit 10′ can perform processes according to programs, thereby implementing functions, and has a liquid pressure control unit 15′ as a part of those functions. The liquid pressure control unit 15′ transmits a control signal including an instruction value, to the electric pneumatic regulator 33′, thereby controlling the electric pneumatic regulator 33′, such that the electric pneumatic regulator 33′ regulates the pressure of the gas 4′ to be supplied to the liquid tank 31′ such that the pressure becomes the instruction value.

Here, it is assumed a case where the inside of the liquid tank 31′ has been pressurized to a predetermined pressure (a case where the gas 4′ having a predetermined pressure has been supplied). In this case, the pressure of the flux liquid 5′ which is sent from the liquid tank 31′ decrease as time goes on.

Due to sending of the flux liquid 5′, the liquid level height of the flux liquid 5′ stored in the liquid tank 31′ lowers as time goes on. For example, as shown in FIG. 18, the liquid level height of the flux liquid 5′ lowers from a position P1′ to a position P2′. If the liquid level height of the flux liquid 5′ lowers as described above, due to a difference in the energy (differential head) of the flux liquid 5′ stored, a force to send the flux liquid 5′ from the liquid tank 31′ through the supply hose 35′ decreases. By this principle, the pressure of the flux liquid 5′ which is sent from the liquid tank 31′ decreases as time goes on. If the pressure of the flux liquid 5′ which is sent from the liquid tank 31′ decreases, naturally, the pressure of the flux liquid 5′ which is actually supplied to the nozzle 2′ also decreases.

As described above, the pressure of the flux liquid 5′ which is actually supplied to the nozzle 2′ defines a range into which the nozzle 2′ jets the flux liquid 5′. Therefore, if the inside of the liquid tank 31′ is pressurized to a predetermined pressure, the range into which the nozzle 2′ jets the flux liquid 5′ varies as time goes on.

Also, due to a pressure loss in the supply hose 35′, the pressure of the flux liquid 5′ decreases until the flux liquid 5′ moves from the liquid tank 31′ into the nozzle 2′. This pressure loss depends on the viscosity of the flux liquid 5′. As ambient temperature drops, the viscosity of the flux liquid 5′ increases, and thus the pressure loss increases. Therefore, as compared to the summer, the pressure loss is larger in the winter, and as compared to the daytime, the pressure loss is larger in the morning and at night.

For this reason, even if the pressure of the flux liquid 5′ which is sent from the liquid tank 31′ is maintained, the pressure of the flux liquid 5′ which is actually supplied to the nozzle 2′ varies depending on seasons, time, and so on. That is, the range into which the nozzle 2′ jets the flux liquid 5′ varies depending on seasons, time, and so on.

In order to cope with this problem, in the coating apparatus 1′ of the present embodiment, the liquid pressure control unit 15′ of the general control unit 10′ performs liquid pressure control to maintain the pressure of the flux liquid 5′, which is actually supplied to the nozzle 2′, substantially at the constant value. The liquid pressure control is a feedback control for controlling the electric pneumatic regulator 33′ on the basis of the pressure of the flux liquid 5′ detected by the liquid pressure sensor 37′ and regulating the pressure of the gas 4′ to be supplied to the liquid tank 31′, thereby maintaining the pressure of the flux liquid 5′ which is supplied to the nozzle 2′, substantially at the constant value.

The liquid pressure sensor 37′ is provided in the vicinity of the connection portion of the supply hose 35′ and the supply port 21′ of the nozzle 2′. The liquid pressure sensor 37′ detects the pressure of the flux liquid 5′ in the supply hose 35′ at the position of the liquid pressure sensor. As described above, due to a pressure loss in the supply hose 35′, the pressure of the flux liquid 5′ decreases until the flux liquid 5′ is supplied from the liquid tank 31′ into the nozzle 2′. For this reason, if the liquid pressure sensor 37′ is provided in a portion of the supply hose 35′ in the vicinity of the liquid tank 31′, it is impossible to correctly detect the pressure of the flux liquid 5′ which is actually supplied to the nozzle 2′. In the coating apparatus 1′ of the present embodiment, since the liquid pressure sensor 37′ is provided in a portion of the supply hose 35′ close to the connection portion of the supply hose 35′ with the nozzle 2′, it can correctly detect the pressure of the flux liquid 5′ which is actually supplied to the nozzle 2′, without being affected by a pressure loss in the supply hose 35′.

### 4-3. Liquid Pressure Control

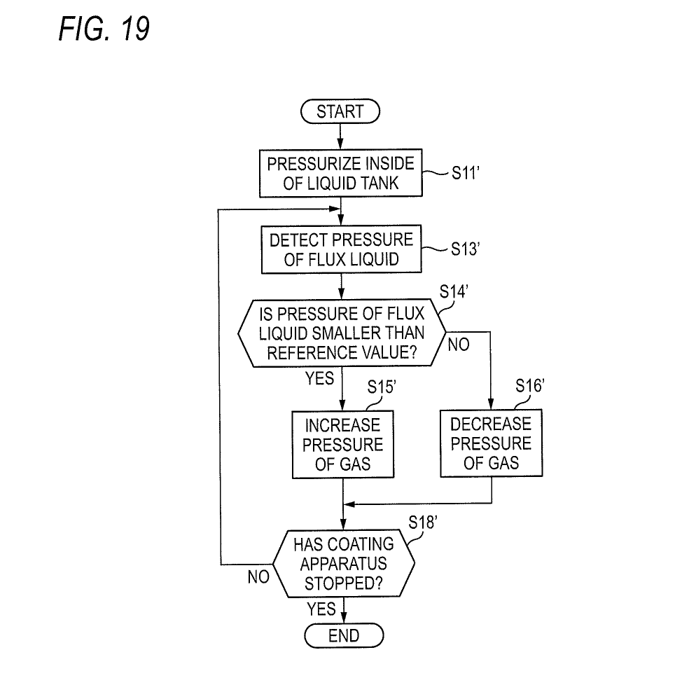

Now, a flow of processes which includes liquid pressure control and is performed by the liquid pressure control unit 15′ will be described. FIG. 19 is a view illustrating the flow of the processes of the liquid pressure control unit 15′.

If the coating apparatus 1′ is activated, first, in STEP S11′, the liquid pressure control unit 15′ controls the electric pneumatic regulator 33′ such that the electric pneumatic regulator supplies the gas 4′ into the liquid tank 31′, thereby pressurizing the inside of the liquid tank 31′. The liquid pressure control unit 15′ controls the electric pneumatic regulator 33′ such that the pressure of the gas 4′ in the liquid tank 31′ exceeds a predetermined reference value (for example, 50 kPa).

If the inside of the liquid tank 31′ is pressurized, the pressurized flux liquid 5′ is sent from the liquid tank 31′ through the supply hose 35′. As a result, the pressurized flux liquid 5′ is supplied to the nozzle 2′ through the supply hose 35′.

If the liquid pressure control unit 15′ determines that the pressure of the flux liquid 5′ to be supplied to the nozzle 2′ is close to the reference value, on the basis of the detection value of the liquid pressure sensor 37′, the liquid pressure control unit performs liquid pressure control such that the pressure of the flux liquid 5′ to be supplied to the nozzle 2′ is maintained substantially at the constant value (the reference value). Thereafter, in parallel to the liquid pressure control, a coating process of applying the flux liquid 5′ on a printed circuit board 8′ is performed according to control of the general control unit 10′.

In the liquid pressure control, first, in STEP S13′, the liquid pressure sensor 37′ detects the pressure of the flux liquid 5′ in the supply hose 35′. That is, the liquid pressure sensor 37′ detects the pressure of the flux liquid 5′ which is actually supplied to the nozzle 2′.

The liquid pressure control unit 15′ receives a signal representing the detection value from the liquid pressure sensor 37′, thereby acquiring the pressure of the flux liquid 5′ in the supply hose 35′. Thereafter, in STEP S14′, the liquid pressure control unit 15′ compares the acquired pressure of the flux liquid 5′ with the reference value.

In a case where the pressure of the flux liquid 5′ is smaller than the reference value (“Yes” in STEP S14′), in STEP S15′, the liquid pressure control unit 15′ transmits a control signal representing an instruction value larger than the previous value to the electric pneumatic regulator 33′, thereby increasing the pressure of the gas 4′ which is supplied to the liquid tank 31′. As a result, the pressure of the gas 4′ in the liquid tank 31′ increases, whereby the pressure of the flux liquid 5′ which is supplied from the liquid tank 31′ into the nozzle 2′ increases.

Meanwhile, in a case where the pressure of the flux liquid 5′ is larger than the reference value (“No” in STEP S14′), in STEP S16′, the liquid pressure control unit 15′ transmits a control signal representing an instruction value smaller than the previous value to the electric pneumatic regulator 33′, thereby decreasing the pressure of the gas 4′ which is supplied to the liquid tank 31′. As a result, the pressure of the gas 4′ in the liquid tank 31′ decreases, whereby the pressure of the flux liquid 5′ which is supplied from the liquid tank 31′ into the nozzle 2′ decreases.

This series of processes of STEPS S13′ to S16′ of the liquid pressure control is repeated until the coating apparatus 1′ stops (“No” in STEP S18′).

Therefore, the liquid pressure control unit 15′ controls the electric pneumatic regulator 33′ such that the electric pneumatic regulator regulates the pressure of the gas 4′ to be supplied to the liquid tank 31′, whereby the pressure of the flux liquid 5′ in the supply hose 35′ approximates the reference value. Therefore, during operation of the coating apparatus 1′, the pressure of the flux liquid 5′ which is actually supplied to the nozzle 2′ is maintained substantially at the constant value (the reference value). As a result, in a coating process, it is possible to stabilize the range into which the nozzle 2′ jets the flux liquid 5′, and the nozzle 2′ can accurately apply the flux liquid 5′ on the object areas A1′ of each printed circuit board 8′.

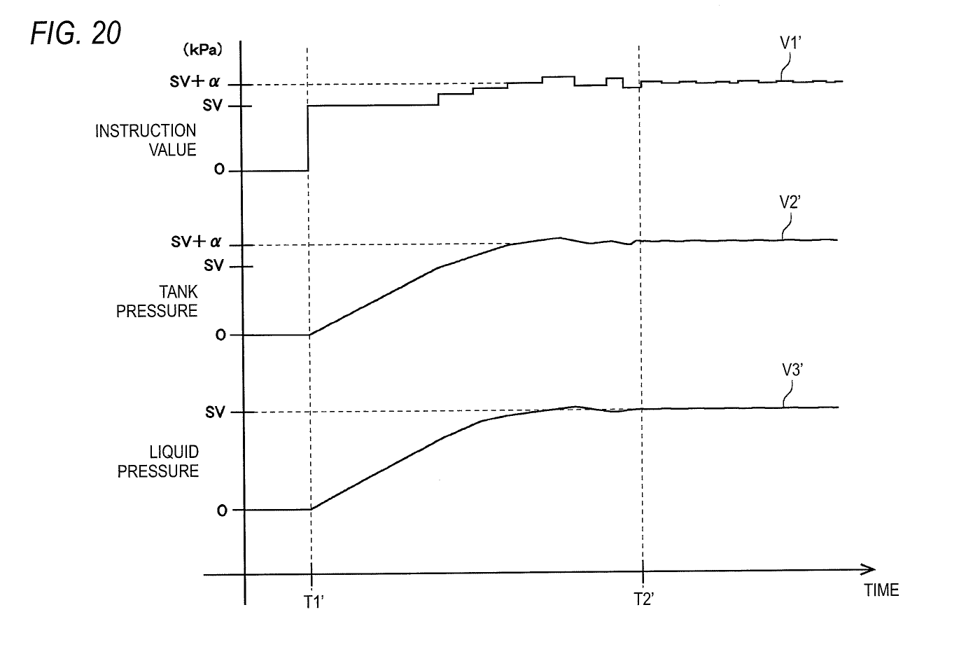

FIG. 20 is a view illustrating variations in an instruction value V1′ of a control signal, a detection value (hereinafter, referred to as “tank pressure”) V2′ of the gas pressure sensor 36′, and a detection value (hereinafter, referred to as “liquid pressure”) V3′ of the liquid pressure sensor 37′ from activation of the coating apparatus 1′.

If the coating apparatus 1′ is activated at a time T1′, the liquid pressure control unit 15′ adjusts the instruction value V1′ of the control signal to a reference value SV with a margin α (for example, α=3 kPa), and controls the electric pneumatic regulator 33′ such that the pressure of the gas 4′ to be supplied to the liquid tank 31′ exceeds a reference value SV. As a result, from the time T1′, both of the tank pressure V2′ and the liquid pressure V3′ increase gradually.

Thereafter, if the liquid pressure V3′ approximates the reference value SV at a time T2′, since then, the liquid pressure control is performed. That is, the liquid pressure control unit 15′ changes the instruction value V1′ of the control signal in real time according to a variation of the liquid pressure V3′, and regulates the pressure of the gas 4′ to be supplied to the liquid tank 31′. Therefore, since the time T2′, the liquid pressure V3′ is maintained substantially at the constant value (the reference value SV).

As described above, in the coating apparatus 1′ of the present embodiment, the gas tank 32′, the electric pneumatic regulator 33′, and the gas hose 34′ supply the gas 4′ into the sealed liquid tank 31′ storing the flux liquid 5′, thereby pressurizing the inside of the liquid tank 31′. Therefore, the flux liquid 5′ is supplied from the liquid tank 31′ into the nozzle 2′ through the supply hose 35′ such that the flux liquid 5′ is jetted from the nozzle. The liquid pressure sensor 37′ detects the pressure of the flux liquid 5′ in the supply hose 35′. On the basis of the pressure of the flux liquid 5′ detected by the liquid pressure sensor 37′, the liquid pressure control unit 15′ performs the liquid pressure control to control the electric pneumatic regulator 33′ such that the electric pneumatic regulator regulates the pressure of the gas 4′ to be supplied to the liquid tank 31′ such that the pressure of the flux liquid 5′ which is supplied to the nozzle 2′ is maintained substantially at the constant value. Therefore, it is possible to stabilize the range into which the nozzle 2′ jets the flux liquid 5′. As a result, even in a case of using a coating method which does not need interposing of a cover member, it is possible to accurately apply the flux liquid 5′ on limited object areas A1′ of each printed circuit board 8′.

Also, since the liquid pressure sensor 37′ is provided in a portion of the supply hose 35′ close to the connection portion of the supply hose 35′ with the nozzle 2′, the liquid pressure sensor 37′ can correctly detect the pressure of the flux liquid 5′ which is actually supplied to the nozzle 2′, without being affected by a pressure loss in the supply hose 35′.

### 5. Fourth Embodiment

Now, a fourth embodiment will be described. The configuration and processes of a coating apparatus 1 of the fourth embodiment are almost similar to those of the third embodiment, and thus differences from the third embodiment will be mainly described below.

In the third embodiment, the liquid pressure control unit 15′ continuously performs the liquid pressure control. In contrast to this, in the fourth embodiment, in a period when the nozzle valve 24′ opens the supply passage 25′, whereby the flux liquid 5′ is jetted from the nozzle 2′, the liquid pressure control unit 15′ does not perform the liquid pressure control.

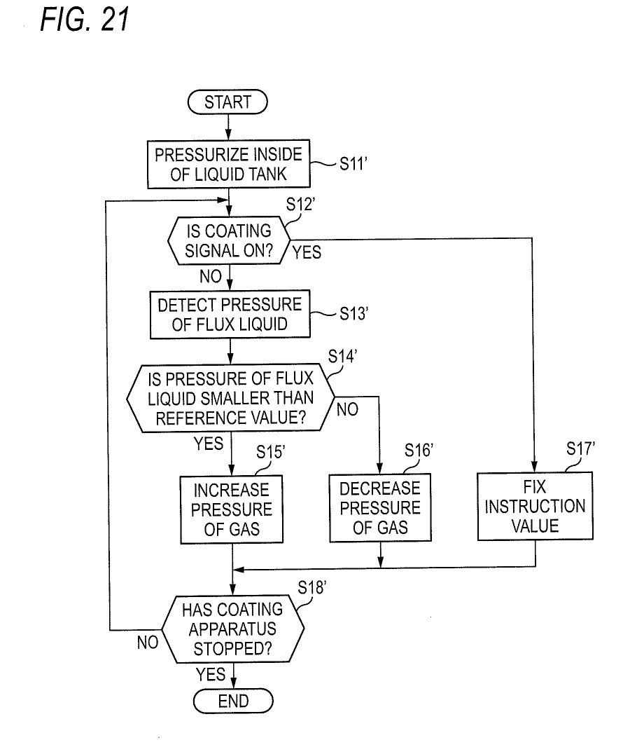

FIG. 21 is a view illustrating a flow of processes of the liquid pressure control unit 15′ of the fourth embodiment. The process flow shown in FIG. 21 can be obtained by adding STEP S12′ and STEP S17 to the process flow shown in FIG. 19.

If the coating apparatus 1′ is activated, first, in STEP S11′, the liquid pressure control unit 15′ controls the electric pneumatic regulator 33′, thereby pressurizing the inside of the liquid tank 31′. If the pressure of the flux liquid 5′ to be supplied to the nozzle 2′ approximates the reference value, since then, the liquid pressure control unit 15′ performs the liquid pressure control in principle. However, under a specific condition, the liquid pressure control unit 15′ does not perform the liquid pressure control.

In STEP S12′, on the basis of the state of the coating signal which is transmitted from the general control unit 10′ to the nozzle valve 24′, the liquid pressure control unit 15′ determines whether to perform the liquid pressure control. As described above, if the coating signal transitions to the ON state, the nozzle valve 24′ opens the supply passage 25′, whereby the flux liquid 5′ is jetted from the nozzle 2′. Meanwhile, if the coating signal transitions to the OFF state, the nozzle valve 24′ closes the supply passage 25′, whereby jetting of the flux liquid 5′ from the nozzle 2′ is stopped.

In a period when the coating signal is in the OFF state (“No” in STEP S12′), that is, in a period when the nozzle valve 24′ closes the supply passage 25′, the liquid pressure control unit 15′ performs the liquid pressure control like in the third embodiment. In STEPS S13′ to S16′, the liquid pressure control unit 15′ changes the instruction value of the control signal according to the pressure of the flux liquid 5′ detected by the liquid pressure sensor 37′, and regulates the pressure of the gas 4′ to be supplied to the liquid tank 31′, thereby maintaining the pressure of the flux liquid 5′ to be supplied to the nozzle 2′, substantially at the constant value.

Meanwhile, in a period when the coating signal is in the ON state (“Yes” in STEP S12′), that is, in a period when the nozzle valve 24′ opens the supply passage 25′, the liquid pressure control unit 15′ does not perform the liquid pressure control. In STEP S17′, the liquid pressure control unit 15′ fixes the instruction value of the control signal at a value immediately before the coating signal transitioned to the ON state. Therefore, in the period when the coating signal is in the ON state, even though the liquid pressure control is not performed, and the pressure of the gas 4′ to be supplied to the liquid tank 31′ is maintained subsequently at the constant value.

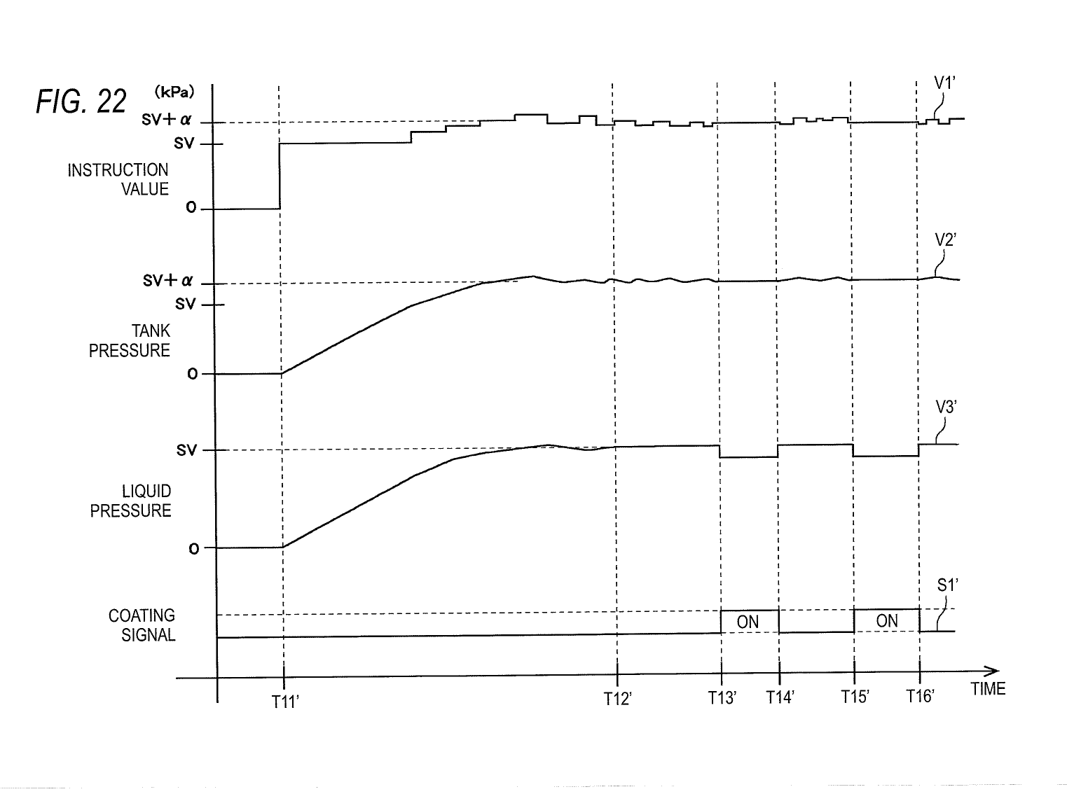

FIG. 22 is a view illustrating variations in the instruction value V1′, the tank pressure V2′, and the liquid pressure V3′ from activation of the coating apparatus 1′ according to the fourth embodiment.

If the coating apparatus 1′ is activated at a time T11′, the liquid pressure control unit 15′ adjusts the instruction value V1′ of the control signal, and controls the electric pneumatic regulator 33′ such that the pressure of the gas 4′ to be supplied to the liquid tank 31′ exceeds the reference value. Therefore, since the time T11′, both of the tank pressure V2′ and the liquid pressure V3′ increase gradually.

Thereafter, since a time T12′ when the liquid pressure V3′ is close to the reference value SV, in a period when a coating signal S1′ is in an OFF state, the liquid pressure control unit 15′ performs the liquid pressure control, and in a period when the coating signal S1′ is in an ON state, the liquid pressure control unit 15′ does not perform the liquid pressure control. In FIG. 22, in a period from a time T13′ to a time T14′ and a period from a time T15′ to a time T16′, the coating signal S1′ is in the ON state. Therefore, in these periods, the instruction value V1′ is fixed, and the liquid pressure control is not performed. Each period when the coating signal S1′ is in the ON state is a period required to apply the flux liquid 5′ on one object area A1′, and is, for example, about 2 seconds to 3 seconds.

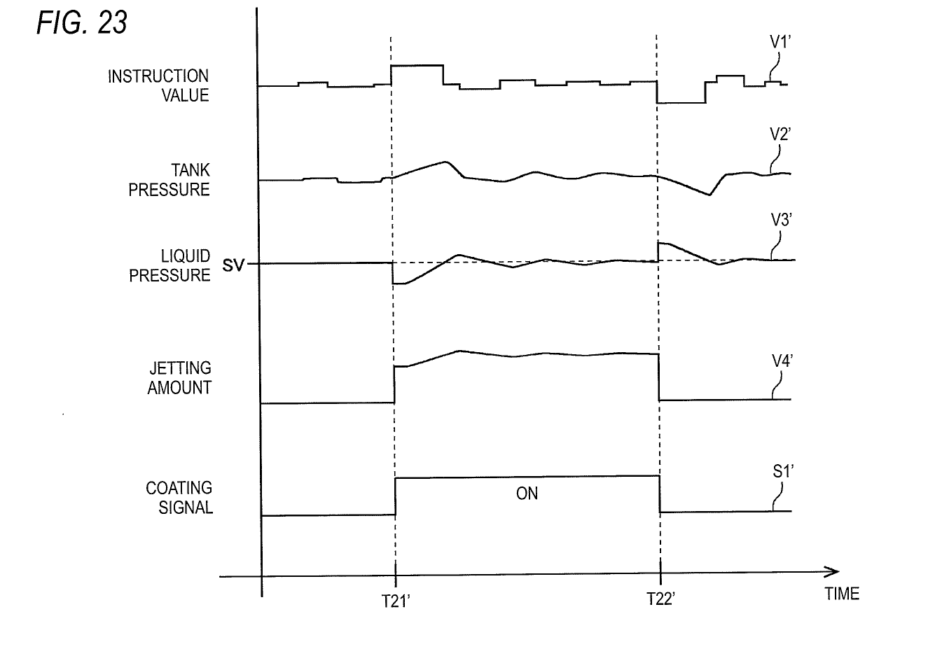

FIG. 23 is a view illustrating variations in an instruction value V1′, a tank pressure V2′, a liquid pressure V3′, and an amount of flux liquid 5′ (hereinafter, referred to as a jetting amount) V4′ which the nozzle 2′ jets in a case where the liquid pressure control unit 15′ continuously performs the liquid pressure control regardless of the state of the coating signal S1′, as comparative examples. In FIG. 23, in a period from a time T21′ to a time T22′, the coating signal S1′ is in the ON state, and in the other periods, the coating signal S1′ is in the OFF state.

Before the time T21′, the liquid pressure V3′ is maintained at the reference value SV by the liquid pressure control. If the coating signal S1′ transitions to the ON state at the time T21′, the nozzle valve 24′ opens the supply passage 25′, whereby the flux liquid 5′ in the supply hose 35′ enters the internal passage 22′ of the nozzle 2′, and then is jetted from the nozzle 2′. Therefore, the pressure of the flux liquid 5′ in the supply passage 25′ instantaneously decreases. That is, the liquid pressure V3′ becomes lower than the reference value SV.

In response to the decrease in the liquid pressure V3′, the liquid pressure control unit 15′ performs the liquid pressure control, thereby changing the instruction value V1′ such that the liquid pressure V3′ approximates the reference value SV. Therefore, the liquid pressure V3′ gradually approximates the reference value SV; however, the liquid pressure V3′ unstably varies for a while.

Due to this variation in the liquid pressure V3′, the jetting amount V4′ also varies. As a result, in a period when the coating signal S1′ is in the ON state (a period when the nozzle 2′ jets the flux liquid 5′), the range into which the nozzle jets the flux liquid 5′ is unstable, and thus there is a possibility that it may be impossible to accurately apply the flux liquid 5′ on a printed circuit board 8′.

Also, if the coating signal S1′ transitions to the OFF state at the time T22′, the nozzle valve 24′ closes the supply passage 25′. Therefore, the pressure of the flux liquid 5′ in the supply hose 35′ instantaneously increases. Therefore, since the time T22′, due to the liquid pressure control of the liquid pressure control unit 15′, the liquid pressure V3′ unstably varies for a while.

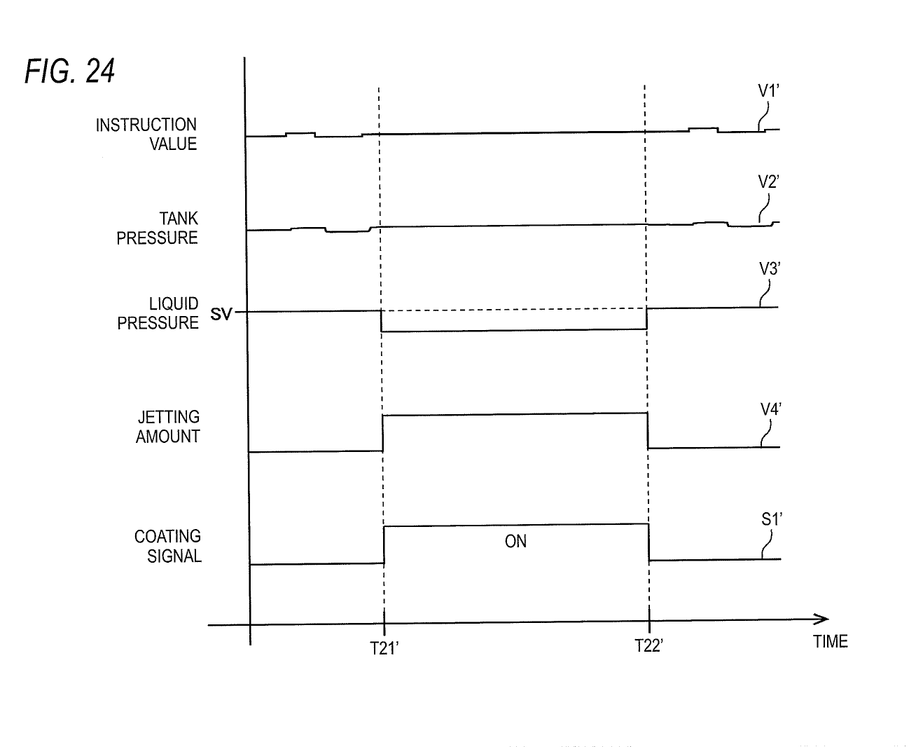

FIG. 24 is a view illustrating an instruction value V1′, a tank pressure V2′, a liquid pressure V3′, and a jetting amount V4′ in a case of the present embodiment in which the liquid pressure control unit 15′ does not perform the liquid pressure control in a period when the coating signal S1′ is in the ON state. Even in FIG. 24, in a period from a time T21′ to a time T22′, the coating signal S1′ is in the ON state, and in the other periods, the coating signal S1′ is in the OFF state.

Even in this case, before the time T21′, the liquid pressure V3′ is maintained at the reference value SV by the liquid pressure control. If the coating signal S1′ transitions to the ON state at the time T21′, the liquid pressure V3′ instantaneously decreases.

Since the liquid pressure control unit 15′ does not perform the liquid pressure control in a period when the coating signal S1′ is in the ON state, even though the liquid pressure V3′ decreases as described above, the instruction value V1′ is fixed at a value immediately before the time T21′. Therefore, the liquid pressure V3′ is stabilized in a state it is lower than the reference value SV. Since a period when the coating signal S1′ is in the ON state is a relatively short period (for example, about 2 seconds to 3 seconds), in this period, even if a differential head or a pressure loss occurs, the pressure of the flux liquid 5′ to be supplied to the nozzle 2′ does not significantly vary. Therefore, in a period when the coating signal S1′ is in the ON state (a period when the nozzle 2′ jets the flux liquid 5′), it is possible to stabilize the range into which the nozzle jets the flux liquid 5′, and it is possible to accurately apply the flux liquid 5′ on a printed circuit board 8′.

As described above, in the coating apparatus 1′ of the fourth embodiment, in a period when the nozzle valve 24′ closes the supply passage 25′, the liquid pressure control unit 15′ performs the liquid pressure control; whereas in a period when the nozzle valve 24′ opens the supply passage 25′, the liquid pressure control unit does not perform the liquid pressure control. Therefore, in a period when the nozzle 2′ jets the flux liquid 5′, it is possible to stably jet the flux liquid 5′.

### 6. Modifications

Although the third and fourth embodiments of the present invention have been described above, the present invention is not limited to the above described embodiments, and can be variously modified. Hereinafter, those modifications will be described. All forms including the above described third and fourth embodiments and the following embodiments to be described below can be appropriately combined.

In the above described embodiments, the liquid pressure sensor 37′ detects the pressure of the flux liquid 5′ in the supply hose 35′, and outputs a signal representing the detection value to the general control unit 10′. In contrast to this, the liquid pressure sensor 37′ may detect the pressure of the flux liquid 5′, and output only two pulse signals representing results obtained by comparing the detection value with two threshold values (an upper limit value and a lower limit value), to the general control unit 10′. The two pulse signals are a first signal which is in an ON state when the detection value exceeds the upper limit value, and a second signal which is in an ON state when the detection value is less than the lower limit value. In this case, the liquid pressure control unit 15′ can perform the liquid pressure control by a simple process of decreasing the instruction value if the first signal transitions to the ON state, and increasing when the second signal transitions to the ON state.

Also, in the above described embodiments, the gas 4′ is supplied to the liquid tank 31′, whereby the flux liquid 5′ is supplied from the liquid tank 31′ into the nozzle 2′. However, the flux liquid 5′ may be supplied from the liquid tank 31′ into the nozzle 2′ by a squeeze pump. Even in this case, since the pumping capacity of the squeeze pump varies depending on the detection value of the liquid pressure sensor 37′, it is possible to maintain the pressure of the flux liquid 5′ which is supplied to the nozzle 2′, substantially at the constant value.

Hereinafter, fifth and sixth embodiments of the present invention will be described with reference to the drawings.

### 7. Fifth Embodiment

### 7-1. Outline of Coating Apparatus

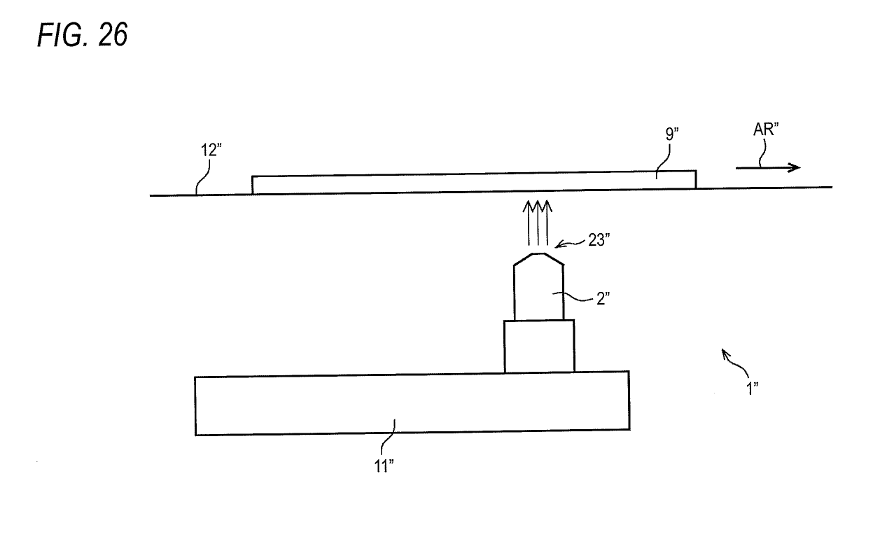

FIG. 26 is a view illustrating an outline of a coating apparatus 1″ according to the fifth embodiment. In a process of manufacturing printed circuit boards 9″, the coating apparatus 1″ performs a coating process of applying a flux liquid on each printed circuit board 9″, as a pre-process of soldering. The coating apparatus 1″ transfers each printed circuit board 9″ which is a coating object, and applies the flux liquid on the lower surface of the corresponding printed circuit board 9″.

The printed circuit board 9″ has various electronic components mounted thereon as objects to be soldered. The coating apparatus 1″ selectively applies the flux liquid on some object areas (areas where the electronic components are disposed) of the lower surface of each printed circuit board 9″ as described above. The object areas become objects to be soldered. The coating apparatus 1″ includes a board transfer unit 12 for transferring printed circuit boards 9″, a nozzle 2″ for jetting the flux liquid, and a nozzle moving unit 11″ for moving the nozzle 2″.

The board transfer unit 12″ includes a conveyor for moving palettes (not shown), and so on. The board transfer unit 12″ moves printed circuit boards 9″ mounted on the palettes, substantially in a horizontal direction as shown by an arrow AR in FIG. 26. Each printed circuit board 9″ is moved to a predetermined processing position by the board transfer unit 12″, and is stopped at the processing position. In this state, the corresponding printed circuit board 9″ is coated. If the coating process is completed, the printed circuit board 9″ is moved again by the board transfer unit 12″, and is discharged to the outside of the coating apparatus 1″.

The nozzle 2″ is, for example, a spray nozzle for spraying the flux liquid. In a coating process, the nozzle 2″ applies the flux liquid on each printed circuit board 9″ disposed at the processing position. The nozzle 2″ jets the flux liquid upward from a nozzle opening 23″ formed in the upper portion of the nozzle, thereby applying the flux liquid on the lower surface of each printed circuit board 9″.

The nozzle moving unit 11″ is, for example, a Cartesian coordinate robot having the nozzle 2″ fixed thereon, and moves the nozzle 2″ in two axis directions along a substantially horizontal direction. In a coating process, the nozzle moving unit 11″ moves the nozzle 2″ along object areas of a printed circuit board 9″ to be objects to be soldered. Therefore, the nozzle 2″ can selectively apply the flux liquid only on the object areas of the printed circuit board 9″.

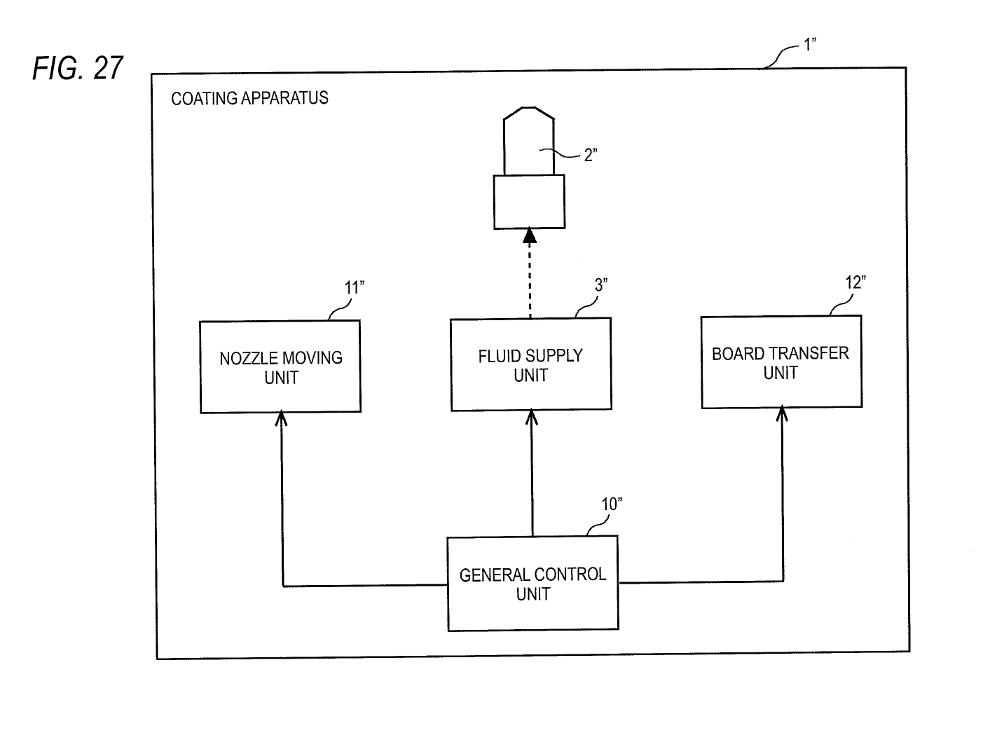

FIG. 27 is a block diagram illustrating a rough configuration of the coating apparatus 1″. The coating apparatus 1″ includes a general control unit 10″ and a fluid supply unit 3″, in addition to the board transfer unit 12″, the nozzle 2″, and the nozzle moving unit 11″ described above.

The general control unit 10″ is, for example, a programmable logic controller (PLC). The general control unit 10″ performs processes according to programs, thereby generally controlling operations of the board transfer unit 12″, the nozzle moving unit 11″, and the fluid supply unit 3″.

The fluid supply unit 3″ supplies a fluid such as the flux liquid into the nozzle 2″. In a coating process, the fluid supply unit 3″ supplies the flux liquid into the nozzle 2″ such that the flux liquid is jetted from the nozzle 2″. Also, the fluid supply unit 3″ can supply a cleaning liquid into the nozzle 2, thereby cleaning the inside of the nozzle 2″.

### 7-2. Configuration of Fluid Supply Unit

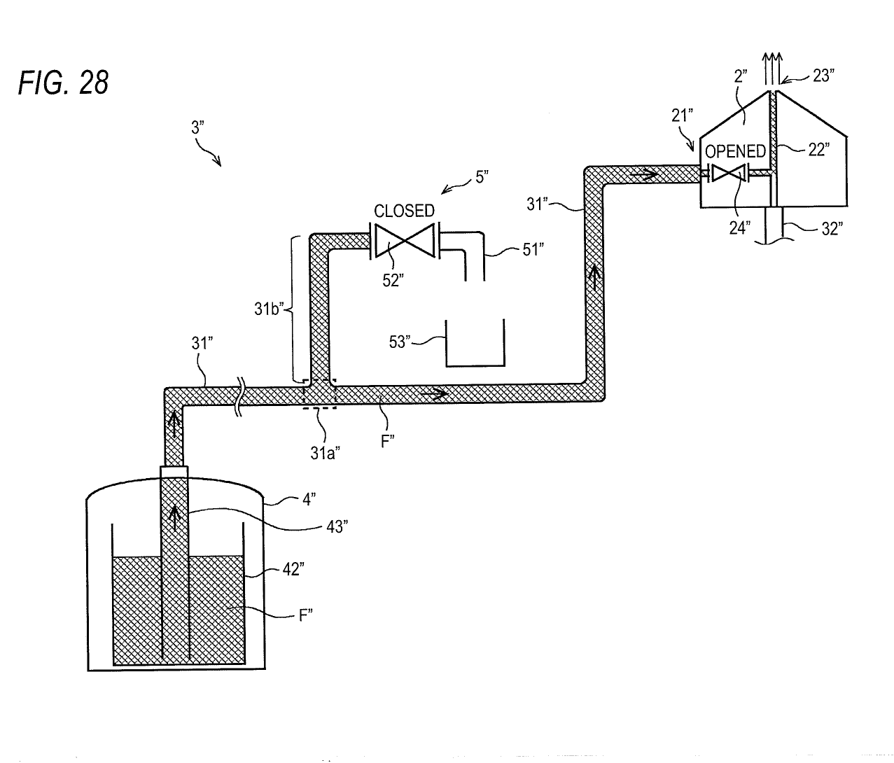

FIG. 28 shows the configuration of the fluid supply unit 3″ together with the nozzle 2″. The fluid supply unit 3″ includes a supply hose 31″ which is a conducting pipe for conducting a flux liquid F″ into the nozzle 2″, a liquid tank 4″, and a bubble discharging unit 5″. The flux liquid F″ is, for example, a liquid obtained by diluting a flux base material such as rosin with a diluent such as isopropyl alcohol (IPA).

The nozzle 2″ includes a nozzle valve 24″, which is disposed on a passage connecting a supply port 21″ and an internal passage 22″. The nozzle valve 24″ is a two-way valve for opening and closing the passage connecting the supply port 21″ and the internal passage 22″, according to control of the general control unit 10″. If the nozzle valve 24″ closes that passage, supply of the flux liquid F″ from the supply hose 31″ into the internal passage 22″ is stopped. If the flux liquid F″ is supplied from the supply hose 31″ into the nozzle 2″, the flux liquid F″ enters the internal passage 22″ of the nozzle 2″, and is pressurized by a gas which is supplied from a gas hose 32″ connected to a lower portion of the nozzle 2″, thereby atomizing. Therefore, the nozzle 2″ sprays the flux liquid F″ from the nozzle opening 23″.

The supply hose 31″ is a transparent hollow tube formed of an elastic material such as rubber or vinyl. One end of the supply hose 31″ is connected to the supply port 21″ of the nozzle 2″, and the other end is connected to the liquid tank 4″. A length from the supply port 21″ of the nozzle 2″ to the liquid tank 4″ is about 3 m to 4 m. Also, a portion of the supply hose 31″ is disposed substantially horizontally. At the portion disposed substantially horizontally, a branching point 31a″ of the supply hose 31″ is formed, and a supply branch passage 31b″ is formed upward from the branching point 31a″. A vertically upward direction is a direction in which bubbles rise up in a liquid. To the branch passage 31b″, the bubble discharging unit 5″ is connected.

The liquid tank 4″ is a supply source for supplying the flux liquid F″, and is an airtight container which contains a liquid container 42″ storing the flux liquid F″. The liquid container 42″ is a so-called nine-gallon drum or the like. The inside of the liquid tank 4″ is pressurized by a compressed gas, whereby the pressurized flux liquid F″ is sent through the supply hose 31″. In the liquid container 42″ of the liquid tank 4″, one end of a hard suction pipe 43″ formed of plastic, a metal, or the like is inserted. The other end of the suction pipe 43″ is connected to the supply hose 31″.

The bubble discharging unit 5″ is a mechanism for discharging bubbles in the supply hose 31″. If a discharge valve 52″ of the bubble discharging unit 5″ is opened, bubbles rising up in the flux liquid F″ is discharged together with the flux liquid F″ from an outlet 51″. The discharged flux liquid F″ containing bubbles is collected in a discharge container 53″, and then is discarded. The bubble discharging unit 5″ is disposed in the vicinity of the liquid tank 4″.

The discharge valve 52″ is a two-way valve connecting the branch passage 31b″ and the outlet 51″. Normally, the discharge valve 52″ is closed so as to block the branch passage 31b″ and the outlet 51″, and is manually opened by an operator of the coating apparatus 1″. Also, the opening of the discharge valve 52″ can be adjusted like a cock which is used in a water faucet.

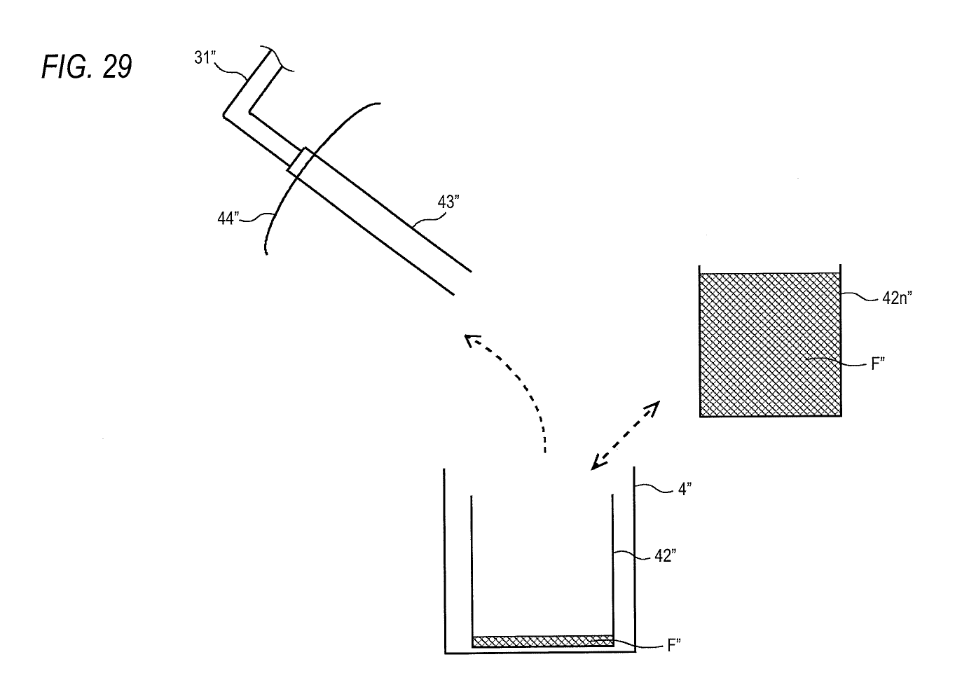

FIG. 29 is a view for explaining exchanging of the liquid container 42″ storing the flux liquid F″. If the residual amount of flux liquid F″ in the liquid container 42″ of the liquid tank 4″ becomes small, it is required to replenish the flux liquid F″. In this case, the flux liquid F″ is replenished by exchanging the liquid tank 4″ containing a small amount of flux liquid F″ with a liquid container 42n″ containing a sufficient amount of flux liquid F″.

Exchanging of the liquid container 42″ is performed after an upper lid 44″ of the liquid tank 4″ is opened. On the upper lid 44″, the supply hose 31″ and the suction pipe 43″ are fixed. For this reason, if the upper lid 44″ is opened, one end of the suction pipe 43″ is exposed to outside air, and thus air enters the suction pipe. After the liquid container 42″ is exchanged, even though and the upper lid 44″ is closed, whereby one end of the suction pipe 43″ is inserted into the liquid container 42″, air remains in the suction pipe 43″.

In a state where there is residual air in the suction pipe 43″, if the liquid tank 4″ is pressurized such that the flux liquid F″ is sent out, and the flux liquid F″ is jetted from the nozzle 2″, the air becomes bubbles, which move toward the nozzle 2″ in the supply hose 31″. In this case, if the bubbles are jetted together with the flux liquid F″ from the nozzle 2″, application unevenness occurs and causes coating defects.

### 7-3. Operations of Coating Apparatus

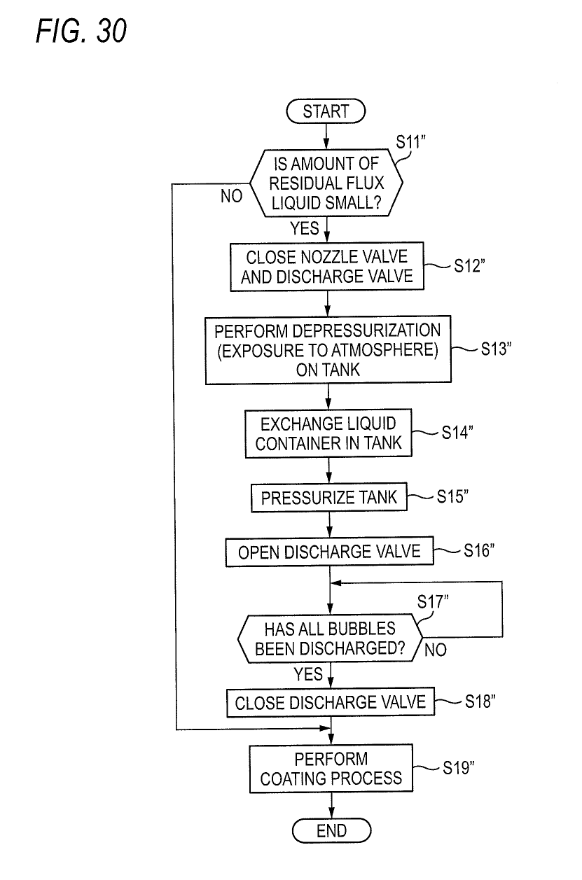

FIG. 30 shows a flow of operations from activation of the coating apparatus 1″ until stop of the coating apparatus. In the operations shown in FIG. 30, operations of the operator of the coating apparatus 1″ are also included.

First, in STEP S11″, whether the amount of flux liquid in the liquid container 42″ is small is determined. The residual amount of flux liquid may be visually determined through sight glass of the liquid container 42″ by the operator. Alternatively, a liquid amount sensor may be provided such that the residual amount of flux liquid can be determined on the basis of a value shown by the sensor.

If it is determined that the amount of flux liquid is not small (“No” in STEP S11″), in STEP S18″, the nozzle valve 24″ is opened, and a coating process starts.

Meanwhile, if it is determined that the amount of flux liquid is small (“Yes” in STEP S11″), in STEP S12″, the nozzle valve 24″ and the discharge valve 52″ are closed.

If the nozzle valve 24″ and the discharge valve 52″ are closed, in STEP S13″, depressurization (exposure to the atmosphere) is performed on the liquid tank 4″. Subsequently, in STEP S14″, the operator exchanges the liquid container 42″ in the liquid tank 4″. That is, the operator takes out the liquid container 42″ containing the small amount of flux liquid F″ from the liquid tank 4″, and installs the new liquid container 42n″ containing a sufficient amount of flux liquid F″ in the liquid tank 4″, as shown in FIG. 29. At this time, the suction pipe 43″ is exposed to outside air, and air enters the suction pipe. This air causes bubble generation in the supply hose 31″ as described above.

If exchanging of the liquid container 42″ is completed, in STEP S15″, the liquid tank 4″ is airtightly closed and is pressurized.

If the liquid tank 4″ is pressurized, in STEP S16″, the discharge valve 52″ is opened, whereby the flux liquid F″ is sent toward the nozzle 2″ through the supply hose 31″ by pressure. At this moment, the air having entered the suction pipe 43″ becomes bubbles, which enter the supply hose 31″.

Since the flux liquid F″ is sent through the supply hose 31″ by pressure, the bubbles in the supply hose 31″ are discharged from the opened discharge valve. In STEP S17″, whether all bubbles have been discharged is visually determined by the operator. Since the supply hose 31″ is formed of a transparent material, the operator can visually recognize bubbles which are moved through the supply hose 31″ by pressure.

In a case where all bubbles in the supply hose 31″ have not been discharged (“No” in STEP S17″), the operator waits for all bubbles to be discharged.

In a case where all bubbles in the supply hose 31″ have been discharged (“Yes” in STEP S17″), in STEP S18″, the discharge valve 52″ is closed.

After the discharge valve 52″ is closed, in STEP S19″, the nozzle valve 24″ is opened, and a coating process is performed.

As described above, after all of bubbles generated in the supply hose 31″ during exchanging of the liquid container 42″ are discharged, it is possible to perform a process of applying the flux liquid F″.

Also, the operations of FIG. 30 are repeatedly performed. That is, the residual amount of flux liquid F″ in the liquid container 42″ is checked again, and if it is determined that the residual amount is small, a series of operations such as exchanging of the liquid container 42″ is performed.

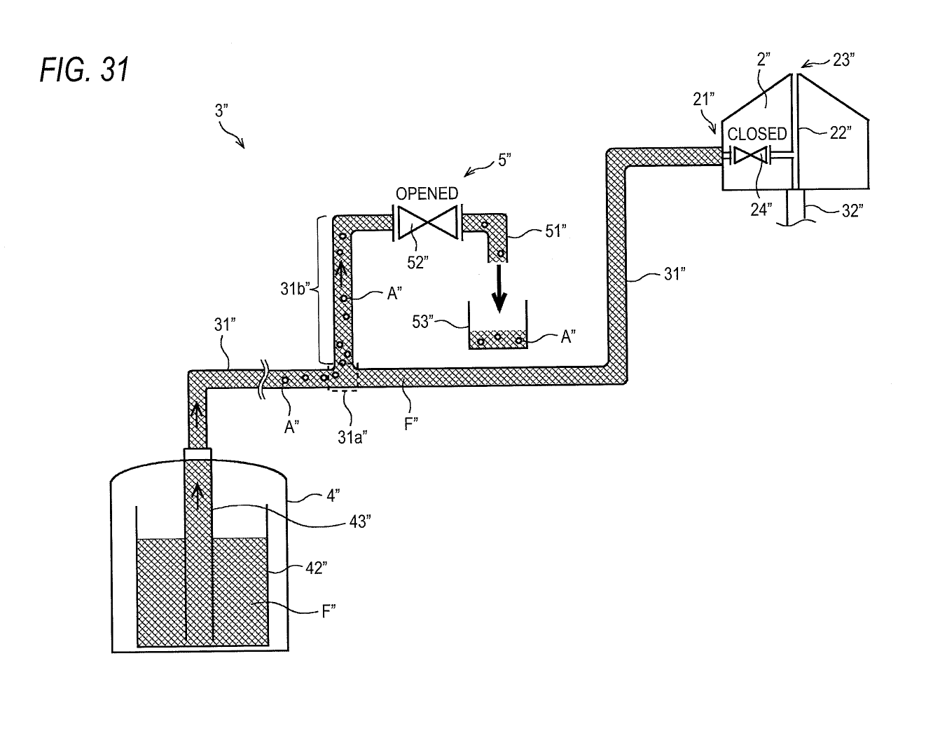

FIG. 31 is a view illustrating a state where bubbles A″ having entered the supply hose 31″ are discharged from the discharge valve 52″. As described above, if air enters the suction pipe 43″ during exchanging of the liquid container 42″, the air becomes bubbles A″, which are moved together with the flux liquid F″ in the supply hose 31″ toward the nozzle 2″ by pressure. The bubbles A″ finally reach the branching point 31a″ of the nozzle 2″ and the bubble discharging unit 5″. At the branching point 31a″, the bubbles A″ enter the branch passage 31b″ extending upward from the supply hose 31″. The reason is that the bubbles A″ have buoyancy to rise up in the flux liquid F″.

The bubbles A″ having risen up in the branch passage 31b″ pass through the opened discharge valve 52″, and are discharged together with the flux liquid F″ from the outlet 51″ into the discharge container 53″. At this moment, since the nozzle valve 24″ is closed, the flux liquid F″ cannot be jetted from the nozzle 2″.

If all bubbles A″ are discharged, the discharge valve 52″ is closed, and the nozzle valve 24″ is opened, and a coating process is performed. At this moment, since the discharge valve 52″ is closed, pressure for delivering the flux liquid F″ is not dispersed toward the nozzle 2″ and the bubble discharging unit 5″, and thus it is possible to effectively perform the coating process. That is, coating defects attributable to dispersion of pressure for delivering the flux liquid F″ do not occur.

### 7-4. Modifications of Fifth Embodiment

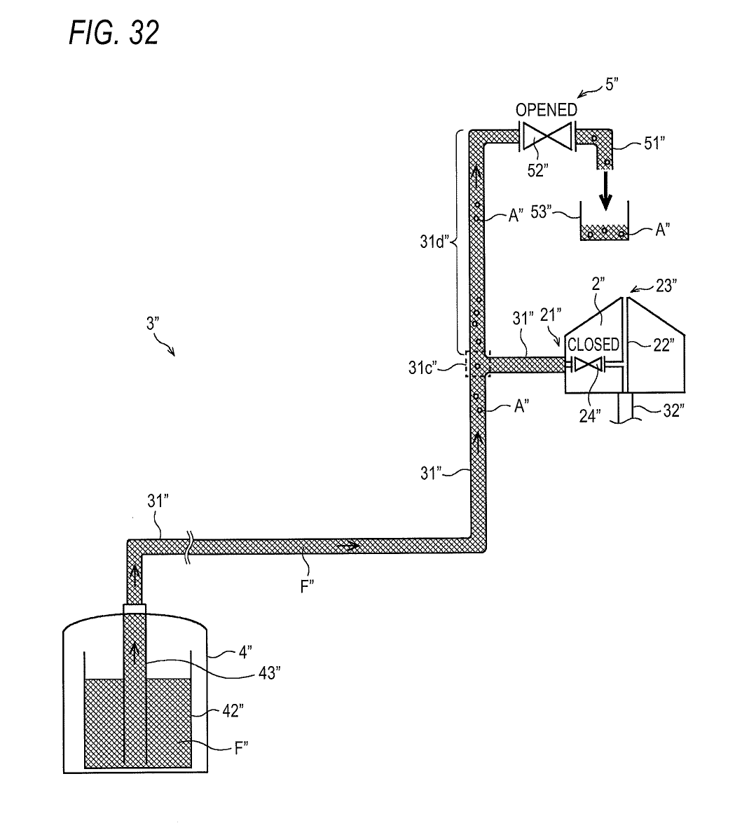

FIG. 32 shows a modification of the fifth embodiment. In the embodiment shown in FIG. 31, at the branching point 31a″ formed in a substantially horizontal portion of the supply hose 31″, the branch passage 31b″ is formed to extend upward.

In the present modification, at a bending point 31c″ which is a portion of the supply hose 31″ bending from a substantially vertical direction to a substantially horizontal direction, a branch passage 31d″ is formed from the supply hose 31″ so as to extend in the same direction as the direction of the substantially vertical portion of the supply hose 31″. At the leading end of a portion of the supply hose 31″ extending upward, the bubble discharging unit 5″ is provided. At the leading end of a portion of the supply hose 31″ extending horizontally from the bending point 31c″, the nozzle 2″ is provided.

In this configuration, bubbles A″ having entered the supply hose 31″ rise up in the substantially vertical portion of the supply hose 31″ and the branch passage 31d″, and reach the bubble discharging unit 5″, and are discharged. Since the portion of the supply hose 31″ which is connected to the nozzle 2″ extends in the horizontal direction from the bending point 31c″, the bubbles A″ rising up cannot enter the horizontal portion of the supply hose 31″ from the bending point 31c″. That is, the bubbles A″ cannot reach the nozzle 2″.

Also, operations of the modification of the fifth embodiment are the same as the operations shown in FIG. 30.

As described above, the coating apparatus 1″ of the present embodiment includes: the airtight liquid tank 4″ which contains the flux liquid F″ in which one end of the supply hose 31″ is submerged, and is pressurized such that the flux liquid F″ is sent from the supply hose 31″; the nozzle 2″ which receives the flux liquid F″ from the liquid tank 4″ through the supply hose 31″, and applies the flux liquid F″ on printed circuit boards; the nozzle valve 24″ which opens and closes a nozzle passage 21″ for conducting the flux liquid F″ contained in the supply hose 31″ into the nozzle 2″; the bubble discharging unit 5″ which collects the bubbles A″ from the supply hose 31″ if the bubbles A″ in the supply hose 31″ rise up due to their buoyancy through the branch passage 31b″ upward formed from a portion of the supply hose 31″, and discharges the bubbles A″ from the outlet 51″; and the discharge valve 52″ which opens and closes the outlet 51″. In this configuration, in a state where the outlet 51″ is opened and the nozzle passage 21″ is closed, the bubble discharging unit 5″ discharges the bubbles A″ together with the flux liquid F″.

Therefore, it is possible to efficiently discharge the bubbles A″, and since the bubbles A″ cannot enter the nozzle 2″, it is possible to prevent coating defects.

Also, the coating apparatus 1″ of the present embodiment discharges bubbles from the bubble discharging unit 5″ or a discharge tank 6″ positioned closer to the suction pipe 43″ than to the nozzle 2″, not from the nozzle 2″. Therefore, it is possible to reduce a waste loss of the flux liquid F″. This is because, if bubbles are discharged from the nozzle 2″, the bubbles are discharged together with all of the flux liquid F″ contained in the supply hose 31″ from the suction pipe 43″ to the nozzle 2″.

### 8. Sixth Embodiment

The sixth embodiment will be described. The sixth embodiment includes components identical to those of the fifth embodiment. For this reason, hereinafter, differences from the fifth embodiment will be mainly described.

### 8-2. Configuration of Fluid Supply Unit

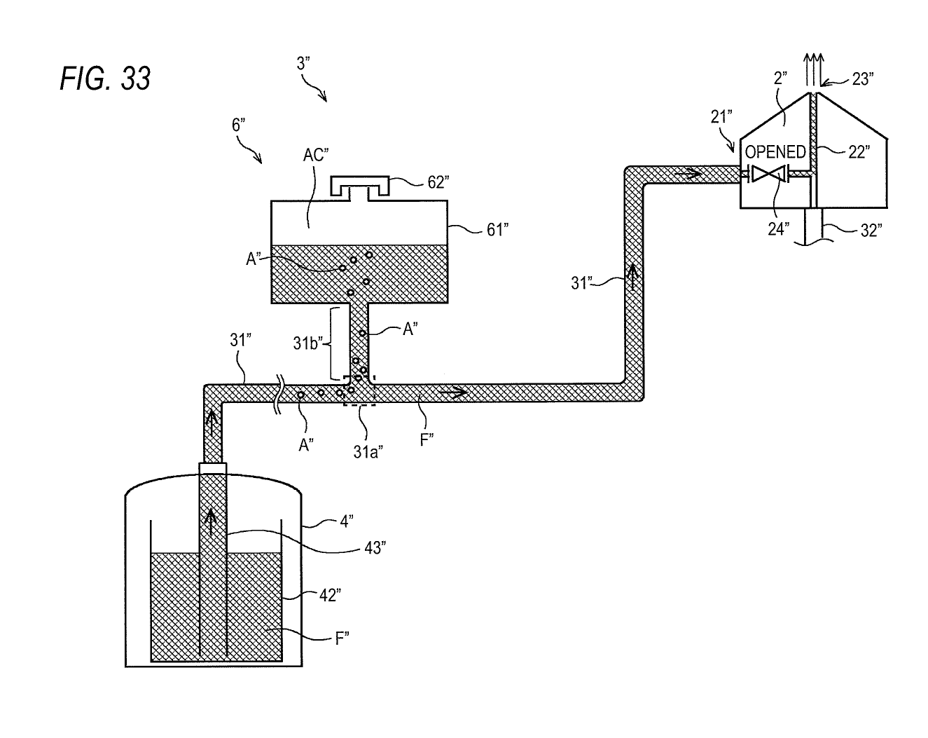

FIG. 33 shows a configuration of a fluid supply unit 3″ according to the sixth embodiment. The fluid supply unit 3″ according to the fifth embodiment includes the bubble discharging unit 5″ which discharges bubbles from the supply hose 31″. In contrast to this, the fluid supply unit 3″ according to the sixth embodiment includes a discharge tank 6″ for discharging bubbles from the supply hose 31″.

The discharge tank 6″ is disposed on the branch passage 31b″ formed upward from the branching point 31a″ of a substantially horizontal portion of the supply hose 31″. If bubbles A″ are delivered in the supply hose 31″ by pressure and rise up from the branching point 31a″ due to their buoyancy, the discharge tank 6″ accumulates the bubbles A″ therein, and discharges the bubbles A″. The discharge tank 6″ includes an accumulation tank 61″ and a discharge cock 62″.

The accumulation tank 61″ is a container for accumulating the bubbles A″ rising up from the branching point 31a″ due to their buoyancy. Prior to accumulation of bubbles A″, the accumulation tank 61″ is filled with the flux liquid F″. If bubbles are accumulated, at the upper portion of the accumulation tank 61″, an air space AC″ is formed.

The discharge cock 62″ is provided in the ceiling of the accumulation tank 61″. If the discharge cock 62″ is opened, the accumulation tank 61″ communicates with outside air having pressure lower than the pressure of the liquid tank 4″. At this moment, the flux liquid F″ which is sent from the liquid tank 4″ by pressure enters the accumulation tank 61″ while pushes up air in the air space AC″, thereby discharging the air in the air space AC″ from the discharge cock 62″. If the accumulation tank 61″ is filled with the flux liquid F″, the discharge cock 62″ is closed, whereby the accumulation tank 61″ is sealed.

### 8-2. Operations of Coating Apparatus

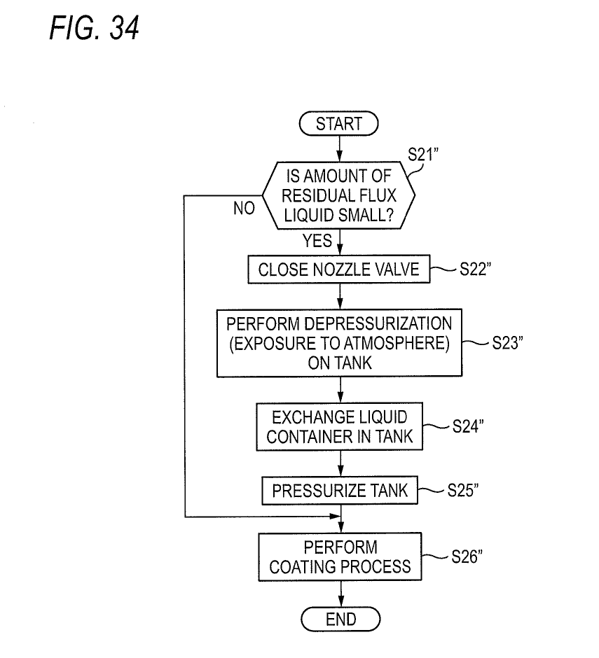

FIG. 34 is a view illustrating a flow of operations from activation of the coating apparatus 1″ until stop of the coating apparatus. In the operations shown in FIG. 30, operations of the operator are also included. During start of the operations shown in FIG. 34, the accumulation tank 61″ is filled with the flux liquid F″, and the discharge cock 62″ is closed.

First, in STEP S21″, whether the amount of flux liquid F″ in the liquid container 42″ is small is determined. The residual amount of flux liquid F″ may be visually determined through sight glass of the liquid container 42″ by the operator. Alternatively, a liquid amount sensor may be provided such that the residual amount of flux liquid can be determined on the basis of a value shown by the sensor.

If it is determined that the amount of flux liquid is not small (“No” in STEP S21″), in STEP S26″, the nozzle valve 24″ is opened, and a coating process is performed.

Meanwhile, if it is determined that the amount of flux liquid is small (“Yes” in STEP S21″), in STEP S22″, the nozzle valve 24″ is closed.

If the nozzle valve 24″ is closed, in STEP S23″, the operator performs depressurization (exposure to the atmosphere) on the liquid tank 4″. Subsequently, in STEP S14″, the operator exchanges the liquid container 42″ in the liquid tank 4″.

If exchanging of the liquid container 42″ is completed, in STEP S25″, the liquid tank 4″ is sealed and is pressurized. If the liquid tank 4″ is pressurized, the flux liquid F″ is sent through the supply hose 31″ toward the nozzle 2″ by pressure. At this moment, the air having entered the suction pipe 43″ becomes bubbles, which enter the supply hose 31″.

Also, the operator does not need to visually determine whether all bubbles A″ contained in the supply hose 31″ have entered the discharge tank 6″. The reason is that the discharge cock 62″ is closed and thus pressure for delivering the flux liquid F″ is not dispersed.

If the liquid tank 4″ is pressurized, in STEP S26″, the nozzle valve 24″ is opened, and a coating process is performed.

Also, the operations of FIG. 34 are repeatedly performed. That is, the residual amount of flux liquid F″ in the liquid container 42″ is checked again, and if it is determined that the residual amount is small, a series of operations such as exchanging of the liquid container 42″ is performed.

In the coating apparatus 1″ according to the sixth embodiment, during a coating process, the discharge cock 62″ is closed, whereby the discharge tank 6″ is sealed. Therefore, it is possible to perform a coating process while accumulating and discharging bubbles A″. Also, since the flux liquid F″ in the discharge tank 6″ does not run over, the degree of freedom of arrangement of the discharge tank 6″ is high. Further, since bubbles A″ are discharged but the flux liquid F″ is not discharged, there is no waste loss of the flux liquid F″.

### 8-3. Modifications of Sixth Embodiment

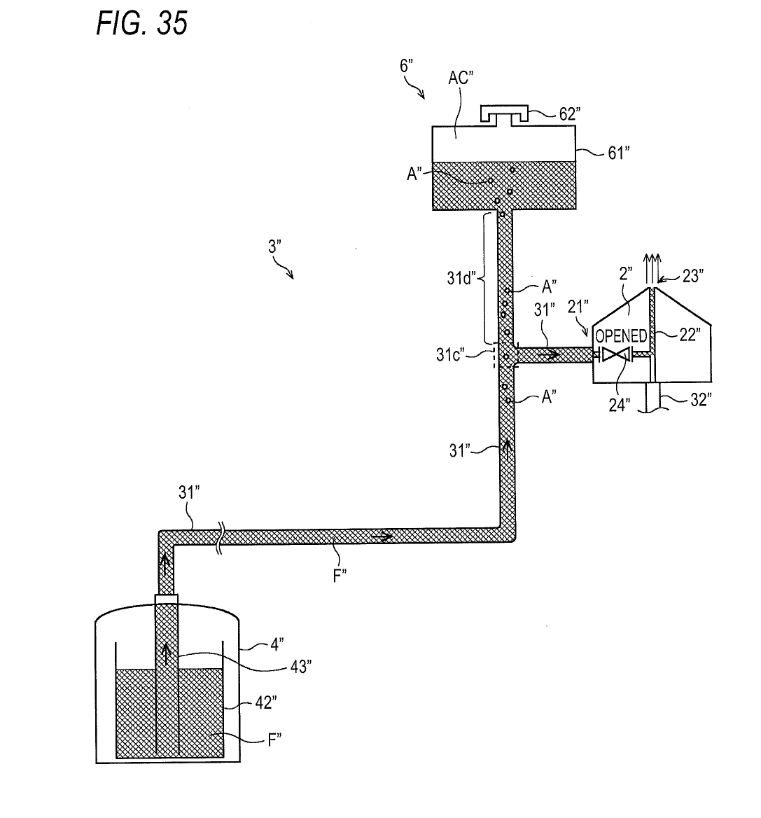

FIG. 35 shows a modification of the fifth embodiment. In the embodiment shown in FIG. 33, at the branching point 31a″ formed in a substantially horizontal portion of the supply hose 31″, the branch passage 31b″ is formed to extend upward.

In the present modification, at a bending point 31c″ which is a portion of the supply hose 31″ bending from a substantially vertical direction to a substantially horizontal direction, a branch passage 31d″ is formed from the supply hose 31″ so as to extend in the same direction as the direction of the substantially vertical portion of the supply hose 31″. At the leading end of a portion of the supply hose 31″ extending upward, the discharge tank 6″ is provided. At the leading end of a portion of the supply hose 31″ extending horizontally from the bending point 31c″, the nozzle 2″ is provided.

In this configuration, bubbles A″ having entered the supply hose 31″ rise up in the substantially vertical portion of the supply hose 31″ and the branch passage 31d″, and reach the discharge tank 6″, and are discharged. Since the portion of the supply hose 31″ which is connected to the nozzle 2″ extends in the horizontal direction from the bending point 31c″, the bubbles A″ rising up cannot enter the horizontal portion of the supply hose 31″ from the bending point 31c″. That is, the bubbles A″ cannot reach the nozzle 2″.

Also, operations of the modification of the sixth embodiment are the same as the operations shown in FIG. 34.

As described above, the coating apparatus 1″ of the present embodiment includes: the accumulation tank 61″ which the bubbles A″ from the supply hose 31″ if the bubbles A″ in the supply hose 31″ rise up due to their buoyancy through the branch passage 31d″ upward formed from a portion of the supply hose 31″, and accumulates the bubbles A″; and the discharge cock 62″ which is provided in the ceiling of the accumulation tank 61″, and is opened such that the bubbles A″ are discharged from the accumulation tank 61″. If the discharge cock 62″ is opened, the flux liquid F″ in the accumulation tank 61″ is pushed up by the pressure of the liquid tank 4″, whereby the bubbles A″ are discharged. According to this configuration, it is possible to easily accumulate bubbles A″ in the accumulation tank 61″, and easily discharge the accumulated bubbles A″.

Also, since the coating apparatus 1″ of the present embodiment does not include the bubble discharging unit 5″ having the discharge valve 52″, an operation on the discharge valve 52″ for discharging bubbles can be omitted.

Also, even though the coating apparatus 1″ of the present embodiment performs a coating process while discharging bubbles from the supply hose 31″, coating defects do not occur. The reason is that bubbles are discharged in a state where the discharge cock 62″ is closed and the accumulation tank 61″ is sealed, and thus pressure for delivering the flux liquid F″ is not dispersed at the branching point.

Until now, the coating apparatuses 1″ according to the fifth and sixth embodiments have been described. Since the coating apparatuses 1″ according to the fifth and sixth embodiments discharge bubbles from the bubble discharging unit 5″ or the discharge tank 6″, not from the nozzle 2″, they further have the following effects.

That is, as compared to a case of discharging bubbles from the nozzle 2″, it is possible to discharge all bubbles in a shorter time. The reason is that, in a case of discharging bubbles from the nozzle 2″, since the flow of liquid is reduced by the nozzle 2″, it takes a long time to discharge all bubbles.

Also, it is possible to reduce a movement distance of the operation for discharging bubbles. The reason is that, since the bubble discharging unit 5″ is disposed close to the liquid tank 4″ as described above, after the liquid tank 4″ is pressurized, the operator does not need to go to the place where the nozzle 2″ for visually checking that bubbles are discharged from the nozzle 2″.

Also, the coating apparatuses 1″ according to the fifth and sixth embodiments do not circulate the flux liquid F″ unlike the technology of Japanese Patent Application Laid-Open No. 7-106294 described in the beginning of this specification. For this reason, pressure for delivering the flux liquid F″ is not dispersed at the branching point 31a″ or the bending point 31c″ of the supply hose 31″. Therefore, pressure for delivering the flux liquid F″ into the nozzle 2″ does not decrease, and coating defects do no occur.

### 9. Modifications

The present invention is not limited to the fifth and sixth embodiments, and can be modified. Hereinafter, those modifications will be described. Also, the above described embodiments and the following embodiments to be described below can be appropriately combined.

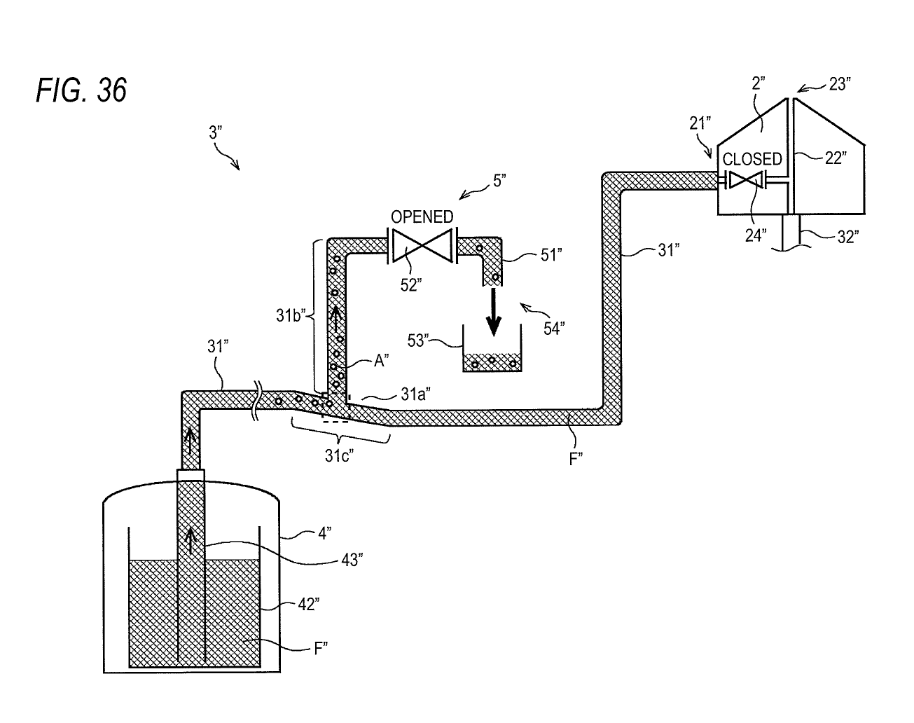

In the above described embodiments, the supply hose 31″ has a substantially horizontal portion. However, as shown in FIG. 36, the supply hose 31″ may have not only a substantially horizontal portion but also a portion which is inclined downward as it goes from the liquid tank (4″) side toward the nozzle (2″) side.

In this case, since it becomes more difficult for bubbles A″ having buoyancy to enter the nozzle (2″) side, it becomes easier for bubbles A″ to enter the branch passage 31d″. Therefore, it is possible to conduct the bubbles A″ into the bubble discharging unit 5″ or the discharge tank 6″ without leakage, and it is possible to effectively prevent the bubbles A″ from entering the nozzle 2″.

Especially, it is effective to incline a portion of the supply hose 31″ including the branching point 31a″ (and having lengths of several centimeters before and after the branching point 31a″). The reason is that bubbles A″ rise up in the branching point 31a″ and enter the bubble discharging unit 5″ or the discharge tank 6″.

Also, it is possible to downwardly incline only a portion of the supply hose 31″ positioned on the nozzle (2″) side from the branching point 31a″. In this case, it is possible to conduct the bubbles A″ into the bubble discharging unit 5″ or the discharge tank 6″ without leakage, and it is possible to effectively prevent the bubbles A″ from entering the nozzle 2″.

Also, a portion of the supply hose 31″ from the bending point 31c″ to the nozzle 2″ shown in the sixth embodiment may be formed to be inclined downward as it goes toward the nozzle (2″) side. In this case, it becomes more difficult for the bubbles A″ to enter the portion of the supply hose 31″ positioned on the nozzle (2″) side from the bending point 31c″, and it is possible to conduct the bubbles A″ into the bubble discharging unit 5″ or the discharge tank 6″ without leakage, and it is possible to effectively prevent the bubbles A″ from entering the nozzle 2″.

Other modifications will be described. In the above described embodiments, the supply hose 31″ for conducting a fluid such as the flux liquid F″ into the nozzle 2″ is formed of an elastic material. However, the supply hose 31″ may be formed of any other material such as a metal.

Also, in the above described embodiments, the nozzle 2″ is a spray nozzle for spraying the flux liquid F″. However, the nozzle 2″ may be a nozzle for jetting the flux liquid F″ without atomizing the flux liquid F″.

Also, in the above described embodiments, the flux liquid is used as a solution. However, any other liquid where buoyancy of bubbles works can be used in the liquid supply unit.

Also, in the above described embodiments, in a case where the residual amount of the flux liquid F″ is small, the liquid container 42″ is exchanged. However, the liquid container 42″ may be directly replenished with the flux liquid F″. Even in this case, it is required to remove the upper lid 44″, and thus air enters the suction pipe 43″ and causes bubble generation in the supply hose 31″.

Also, in the above described embodiments, a portion of the supply hose 31″ is substantially horizontal. A substantially horizontal state includes not only a horizontal state but also a state slightly inclined to a horizontal direction. In the supply hose 31″, a portion including the branching point 31a″ may be slightly inclined to a horizontal direction. Even in this case, the effects of the present invention are exhibited. Similarly, in the supply hose 31″, a portion including the branching point 31a″ may be slightly inclined to a vertical direction.

What is claimed is:

1. A coating apparatus for applying a flux liquid on a coating object, comprising:
a sealed liquid container that stores the flux liquid;
a nozzle that jets the flux liquid;
a pressurizing unit that supplies a gas to the inside of the liquid container, thereby pressurizing the inside of the liquid container, such that the flux liquid is supplied from the liquid container to the nozzle through a conducting pipe;
a detecting unit that detects the pressure of the flux liquid in the conducting pipe; and
a control unit that performs liquid pressure control by regulating the pressure of the gas to be supplied to the inside of the liquid container, on the basis of the pressure of the flux liquid detected by the detecting unit, such that the pressure of the flux liquid to be supplied to the nozzle is maintained substantially at a constant value.

2. The coating apparatus according to claim 1, wherein the detecting unit is provided in the vicinity of a connection portion of the conducting pipe with the nozzle.

3. The coating apparatus according to claim 1, wherein the nozzle applies the flux liquid on the coating object without interposing a cover member for covering some portions of the coating object between the nozzle and the coating object.

4. The coating apparatus according to claim 3, further comprising a valve that opens and closes a supply passage for conducting the flux liquid contained in the conducting pipe into the nozzle,
wherein the valve opens the supply passage, whereby the flux liquid is jetted from the nozzle, and
wherein the control unit:
performs the liquid pressure control in a period when the valve closes the supply passage; and
does not perform the liquid pressure control in a period when the valve opens the supply passage.

5. A coating method of applying a flux liquid on a coating object, comprising:
a step (a) of supplying a gas to the inside of a sealed liquid container storing the flux liquid, thereby pressurizing the inside of the liquid container, such that the flux liquid is supplied from the liquid container to a nozzle for jetting the flux liquid, through a conducting pipe;
a step (b) of detecting the pressure of the flux liquid in the conducting pipe; and
a step (c) of performing liquid pressure control by regulating the pressure of the gas to be supplied to the inside of the liquid container, on the basis of the pressure of the flux liquid detected in the step (b), such that the pressure of the flux liquid to be supplied to the nozzle is maintained substantially at a constant value.

6. The coating method according to claim 5, further comprising a step (d) of allowing a valve for opening and closing a supply passage for conducting the flux liquid contained in the conducting pipe into the nozzle, to open the supply passage, whereby the flux liquid is jetted from the nozzle,
wherein, in the step (c):
the liquid pressure control is performed in a period when the valve closes the supply passage, and
the liquid control is not performed in a period when the valve opens the supply passage.
